(19) United States
(12) Patent Application Publication
(10) Pub. No.: US 2021/0314143 A1
(43) Pub. Date: Oct. 7, 2021

(54) ENCRYPTION FOR BLOCKCHAIN CRYPTOCURRENCY TRANSACTIONS AND USES IN CONJUNCTION WITH CARBON CREDITS

(71) Applicant: Jason Conner, Pinson, AL (US)

(72) Inventor: Jason Conner, Pinson, AL (US)

(21) Appl. No.: 17/268,436

(22) PCT Filed: Apr. 15, 2019
(86) PCT No.: PCT/US2019/027501

§ 371 Date: Feb. 12, 2021

Related U.S. Application Data
(60) Provisional application No. 62/657,909, filed on Apr. 15, 2018.
(60) Provisional application No. 62/673,918, filed on May 20, 2018.

(51) Int. Cl. H04L 9/06; G16Y 40/50; H04L 29/06; H04L 9/32

(52) U.S. Cl. CPC H04L 9/0656; G16Y 40/50; H04L 2209/38; H04L 9/3239; H04L 9/3297; H04L 63/067

(57) ABSTRACT

Encryption for blockchain cryptocurrency. In some embodiments, the encryption is implemented using one-time pad techniques. The key for the one-time pad may be derived from a true random sequence. Data messages are encrypted and decrypted using the one-time pad key. Also disclosed is an Internet-of-Things system that comprises an Internet-connected device that has a sensor that generates a stream measurement data. This stream of measurement data may be the basis for the true random sequence used for deriving the one-time pad key. Also disclosed is a method of trading carbon credits using a cryptocurrency market platform. The blockchain platform may use a proof-of-elapsed time (PoET) protocol for energy-use savings during mining.

### RELATED APPLICATIONS

This application claims the benefit of U.S. Provisional Applications No. 62/673,918 (filed May 20, 2018) and No. 62/657,909 (filed Apr. 15, 2018), and International Patent Application No. PCT/US19/13719 (filed Jan. 15, 2019), all of which are incorporated by reference herein.

### TECHNICAL FIELD

This invention relates to uses for blockchain cryptocurrency.

### BACKGROUND

History of Cryptocurrency: A cryptocurrency is a digital asset designed to work as a medium of exchange that uses cryptography to secure its transactions, to control the creation of additional units, and to verify the transfer of assets. Cryptocurrencies are a type of digital currencies, alternative currencies and virtual currencies. Cryptocurrencies use decentralized control as opposed to centralized electronic money and central banking systems. The decentralized control of each cryptocurrency works through a blockchain, which is a public transaction database, functioning as a distributed ledger. Decentralized cryptocurrency is produced by the entire cryptocurrency system collectively, at a rate that is defined when the system is created and which is publicly known. In centralized banking and economic systems such as the Federal Reserve System, corporate boards or governments control the supply of currency by printing units of fiat money or demanding additions to digital banking ledgers. In case of decentralized cryptocurrency, companies or governments cannot produce new units, and have not so far provided backing for other firms, banks or corporate entities which hold asset value measured in it. The underlying technical system upon which decentralized cryptocurrencies are based was created by the group or individual known as Satoshi Nakamoto. Bitcoin, created in 2009, was the first decentralized cryptocurrency. Since then, numerous other cryptocurrencies have been created. These are frequently called altcoins, as a blend of alternative coin.

As of September 2017, over a thousand cryptocurrency specifications exist; most are similar to and derive from the first fully implemented decentralized cryptocurrency, bitcoin. Within cryptocurrency systems the safety, integrity and balance of ledgers is maintained by a community of mutually distrustful parties referred to as miners: members of the general public using their computers to help validate and timestamp transactions, adding them to the ledger in accordance with a particular timestamping scheme. Miners have a financial incentive to maintain the security of a cryptocurrency ledger.

Most cryptocurrencies are designed to gradually decrease production of currency, placing an ultimate cap on the total amount of currency that will ever be in circulation, mimicking precious metals. Compared with ordinary currencies held by financial institutions or kept as cash on hand, cryptocurrencies can be more difficult for seizure by law enforcement. This difficulty is derived from leveraging cryptographic technologies.

The validity of each cryptocurrency's coins is provided by a blockchain. A blockchain is a continuously growing list of records, called blocks, which are linked and secured using cryptography. Each block typically contains a hash pointer as a link to a previous block, a timestamp and transaction data. By design, blockchains are inherently resistant to modification of the data. It is “an open, distributed ledger that can record transactions between two parties efficiently and in a verifiable and permanent way.” For use as a distributed ledger, a blockchain is typically managed by a peer-to-peer network collectively adhering to a protocol for validating new blocks. Once recorded, the data in any given block cannot be altered retroactively without the alteration of all subsequent blocks, which requires collusion of the network majority.

Blockchains are secure by design and are an example of a distributed computing system with high Byzantine fault tolerance. Decentralized consensus has therefore been achieved with a blockchain. It solves the double spending problem without the need of a trusted authority or central server.

The block time is the average time it takes for the network to generate one extra block in the blockchain. Some blockchains create a new block as frequently as every five seconds. By the time of block completion, the included data becomes verifiable. This is practically when the money transaction takes place, so a shorter block time means faster transactions.

Timestamping: Cryptocurrencies use various timestamping schemes to avoid the need for a trusted third party to timestamp transactions added to the blockchain ledger. Proof-of-work schemes: The first timestamping scheme invented was the proof-of-work scheme. The most widely used proof-of-work schemes are based on SHA-256 and scrypt. The latter now dominates over the world of cryptocurrencies, with at least 480 confirmed implementations. Some other hashing algorithms that are used for proof-of-work include CryptoNight, Blake, SHA-3, and X11.

Proof-of-stake and combined schemes: Some cryptocurrencies use a combined proof-of-work/proof-of-stake scheme. The proof-of-stake is a method of securing a cryptocurrency network and achieving distributed consensus through requesting users to show ownership of a certain amount of currency. It is different from proof-of-work systems that run difficult hashing algorithms to validate electronic transactions. The scheme is largely dependent on the coin, and there's currently no standard form of it.

Wallets: A cryptocurrency wallet stores the public and private “keys” or “addresses” which can be used to receive or spend the cryptocurrency. With the private key, it is possible to write in the public ledger, effectively spending the associated cryptocurrency. With the public key, it is possible for others to send currency to the wallet.

Anonymity: Cryptocurrency is pseudonymous rather than anonymous in that the cryptocurrency within a wallet is not tied to people, but rather to one or more specific keys (or “addresses”). Thereby, cryptocurrency owners are not identifiable, but all transactions are publicly available in the blockchain. Still, cryptocurrency exchanges are often required by law to collect the personal information of their users.

FIG. 1 shows an example of a blockchain system architecture. The blockchain Distributed Ledger Technology (DLT) is a server-based high performance distributed blockchain system that runs behind an Enterprise Security Suite (firewall, etc.) 172, which provides state-of-the-art security protection from direct DLT software hacking as well as distributed denial-of-service (DDOS) attacks from would-be hackers outside the Enterprise Firewall. See secure DLT servers 170. The blockchain secure wallet and mining app is implemented based on the Trusted Execution Environment (TEE) specification. The blockchain TEE wallet and mining software can execute securely on an end user's PC 174 or mobile device 176 even if the PC 174 or device 176 is fully compromised by unfriendly network participants (hackers and unwanted intruders).

The Blockchain TEE environment ensures that the blockchain application has not been tampered with down to the last byte of code at runtime, and that no sensitive information such as passwords and DLT information is exposed to anyone outside the TEE environment. The blockchain TEE environment communicates directly with the blockchain secure DLT servers 170 over a fully encrypted path during software execution, which prevents the possibility of even man-in-the-middle (MITM) attacks. This means data and execution environment are fully protected throughout the blockchain system's entire operation. In fact, the only way to breach the blockchain security would be to hack through an Enterprise Security Suite, which to date has not occurred. And even then, once inside the firewall, a network intruder will then have to hack dozens of servers and modify specific records in the DLT before being identified and “kicked out” of the network, which is considered by most security experts as being a highly unlikely scenario.

### SUMMARY

In one embodiment, the invention is a computer-implemented method of communication between an Internet-connected device and a remote server via the Internet, wherein the connected device comprises a sensor. The method comprises, at the connected device, creating a true random sequence using a source of random data. The connected device registers onto a blockchain ledger. A random sequence is written to the blockchain ledger. At the remote server, the blockchain ledger is received. The random sequence is extracted from the blockchain ledger. A one-time pad key is created using the true random sequence. The one-time pad key is sent to the connected device in a secure manner.

In another embodiment, the invention is an Internet-of-Things system, which comprises an Internet-connected device. This device comprises a sensor that generates a stream measurement data and a computing processor. There is a remote server in communication with the connected device via the Internet. The processor in the connected device is programmed to perform operations comprising: receive the stream of measurement data from the sensor; create a random sequence using the stream of measurement data; register onto a blockchain ledger; and write the random sequence to the blockchain ledger. The remote server is programmed to perform operations comprising: receive the blockchain ledger; extract the random sequence from the blockchain ledger; create a one-time pad key using the random sequence; and send the one-time pad key to the connected device in a secure manner.

In another embodiment, the invention is a method of forming encrypted data for a plurality of user data. The method comprises receiving plurality data from a physical data sensor. The plurality of user data is encrypted via the plurality of received sensor data. An encryption key and encrypted data identifier is forwarded to a user electronically. The encrypted data and its identifier are stored.

In another embodiment, the invention is a method of trading carbon credits using a cryptocurrency market platform. At a first site, carbon credits are obtained. These carbon credits are submitted to a cryptocurrency market platform. Cryptocurrency is issued to the first site and to an account for renewable energy. At a second site, cryptocurrency is mined for the cryptocurrency market platform. Upon completion, cryptocurrency is issued to the second site and to the account for renewable energy. The cryptocurrency in the account for renewable energy is converted into fiat currency. The fiat currency is used to build renewable energy production facilities.

### BRIEF DESCRIPTION OF THE DRAWINGS

FIG. 1 shows an example of a blockchain system architecture.

FIG. 2A shows an example of an Internet-of-Things edge hardware layout. FIG. 2B shows another example of an Internet-of-Things edge hardware layout.

FIG. 3 shows an example of the transactions that may occur in the proposed cryptocurrency market for carbon credit trading.

FIG. 4 shows an example of a sensor-data based encryption architecture.

FIG. 5 is a flow diagram illustrating an example method of the invention.

FIG. 6 is a block diagram illustrating an example method of the invention.

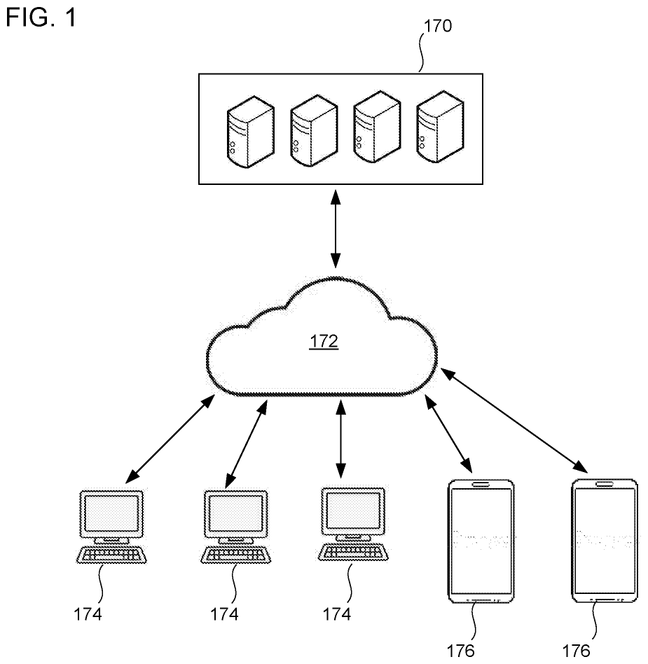

### DETAILED DESCRIPTION

### Application of Blockchain to Devices Operating Internet-of-Things

The Internet-of-Things (IoT) is a new style of architecture that will connect every product electronically, and most likely wirelessly, to the Internet. Many device manufacturers are currently building in sensors with radio communication that would allow the product's internal status, usage patterns, or other information regarding operation or process to be sent out via radio signal to hardware devices that can listen to their communication and transmit that communication to the Internet, or have a computer hardware or software system on the Internet that could send information to the product and have it respond in kind. This two-way communication between the product and the Internet is now being referred to as the “Internet of Things” computing architecture. The means by which the products will primarily communicate to the Internet will be through hardware devices known as gateways and/or routers that can send and/or receive the signals from the product. These communications may or may not occur over a cable and/or “short range” and/or “mid range” communications such as WiFi, RFID, Zigbee, Bluetooth, Openware (our own four-phase commit protocol described in detail in previously mentioned filings), LoRaWAN (LoRa), Sigfox, cellular, satellite, or any other ad-hoc wireless communications protocol in any combination, and then send them to the Internet via a dedicated or intermittent Internet connection (which may be in turn wireline or wireless, or any other combination mentioned above). The routers or gateway devices that are currently available are devices such as Raspberry PI, Android devices, etc. Although these devices will work in limited capacity, they are in no way equipped to handle multiple short range transmission protocols “out of the box” and are not capable of connecting all products in a local environment to a single gateway or router device.

One new router/gateway device design could be a hardware design that can scan a household, manufacturing facility, or other local region for wireless transmissions such as radio signals. Then decode the signal into raw data that the gateway/router device can understand. These wireless transmissions can be WiFi, RFID, Zigbee, Bluetooth, Openware, LoRaWAN (LoRa), Sigfox, cellular, satellite, or any other form of “short range”, “mid range”, or “long range” radio signal protocol or airborne signal otherwise that may be used for IoT systems. Once the signal is decoded, the router can then scan for such signals on a scheduled interval or permanently as to act as a receiver for the signal detected. This will in turn allow the gateway/router to undergo an initial setup routine to decode all signals coming from any radio frequency enabled devices or products and then normalize them into a language the gateway/router can understand. The gateway/router can then transmit the normalized information from one or more devices or products to the Internet such as a cloud environment like Microsoft's Azure platform, Amazon's AWS (Web Services) platform, or some other computer network residing on the Internet or computer communications network. The data can then possibly be stored and/or used to drive business processes such as rules engines or business workflows in real time or at some point in the future. Such processes could include emailing parties when certain information indicates they be notified. As an example, if a refrigerator warms to a certain level that would indicate the cooling system is failing, then a service technician can be notified via text message, email, or other form of communication. The service technician can then be instructed to come out for a service check and possibly fix the refrigerator before all the food spoils. The gateway/router can also support devices being connected by cable directly as opposed to wirelessly for communications.

The scanning mechanism described above can be designed in the following ways. The gateway/router can first scan for a specified period to see which products are transmitting information and record which frequencies, baud rates, and/or additional product information can be picked up through real time detection and/or decryption and/or decoding of individual packets of wireless transmission data. All aspects of the different types of communication received from the product(s) in the local environment by the gateway/router should be recorded. The protocol format(s) that are detected can then be looked up via a database on the gateway/router and the product type(s) and wireless transmission type(s) can be recorded as a local wireless profile for the gateway/router to immediately and/or in the future. The information collected by the scan may also be sent to the Internet for decryption or decoding of the transmission type via a product wireless protocol catalog kept in a database on the Internet. The product type(s) and wireless transmission type(s) can then be send back to the gateway/router as a profile so the gateway/router knows how to communicate with each product in the local environment. This information can be stored and/or used for immediate and/or future use.

Once the local “short range” or “mid range” network protocol(s) are deciphered and/or decoded and the gateway/router knows how to send and receive data transmissions to and from the product(s), then the gateway/router can then poll the different frequencies and baud rates to receive any transmissions from the products on a scheduled or one-time interval. The gateway/router may implement one or more antennas to perform the sending and receiving of transmissions to different products, if more than one product is sending and/or receiving transmissions. If a single antenna is used to communicate with multiple products, then the gateway/device will have to reprogram the antenna and/or computer logic on the gateway/device driving the antenna reception on a programmed time interval or for a single invocation to be able to send and receive on different wireless protocols on scheduled intervals. In other words, the antenna will have to be tunable to receive different frequencies and/or baud rates from potentially different pick parts and possibly additional information if needed to perform having a single antenna send and receive communications from multiple products.

One example of this type of single antenna/multiple wireless protocol in use implementation is if there are five products that can transmit sensor information to the gateway/router. The gateway/router will need to cycle through the different protocols/product types profile created in the setup to scan for all product communications in a given interval at a rate that collectively doesn't exceed the maximum amount of time the products will try to resend information. In other words, if all five products will attempt to transmit for 1 minute before cancelling their transmission to the gateway/router, then the gateway/router will scan on each frequency and baud rate for no more than 12 seconds at a time in a single cycle so that the gateway/router can detect any transmission from any product before the product decides to cancel the transmission. Since there are 5 products in the local environment, 12 seconds of scan for communications from each product will result in 1 minute cycles for scanning all products. This will ensure that one gateway/router device always receives communication initiated by a product. If the gateway/router is designed with multiple antennas, each antenna could be utilized in a way to talk to multiple products or a single individual product per antenna. If each product has a dedicated antenna, then the cycling of scanning for an individual product can be eliminated as each antenna can be constantly listening for communications from each individual product.

Additional information such as pick part type used by the manufacturer and any encryption-scheme specific information or other information may be needed to determine how to decrypt and/or decode the data from the products or transmit information to the products, both of which should be enabled by such a system. Specific product wireless profiles could be built into the gateway/router by the manufacturer and/or configured in advance of deployment, or pushed to the gateway/router so that the scanning mechanism is not needed and the gateway/router is shipped to the customer already configured to communicate with certain products and/or product types, or the wireless profile configuration can be controlled by an interface on the Internet via a cloud-based web interface or any other computer interface such as a mobile device, tablet, etc.

The gateway/router design should implement several security features that will ensure no firmware or data transmissions are ever tampered with or intercepted in clear text. This will require the data transmissions be encrypted from the sensor pack all the way through the gateway/router to the Internet as well as to the client interface. The firmware should be signed through a code certificate mechanism and written to read only data storage on all sensor packs as well as gateway/router devices to ensure no tampering with the hardware. A unique id should be assigned to each piece of hardware used in the system in advance of deployment so that each piece of equipment can be uniquely identified in the system. Data that is no longer needed should be erased from local memory so that no device can retain information sent to or received by the sensors. There should also be a transaction layer that begins at the sensor pack and/or Internet, whoever the originator of the transmission is, that will maintain integrity of communication all the way through the use of the system. This could be implemented as a two phase commit, as current Internet Protocol is designed, or it can be implemented as a four phase commit as described in previously filed patents referenced in the introduction of this patent filing. The gateway/router devices can be implemented in a chain of “grid enabled” devices so that the sensor pack may communicate with the Internet through several gateway/router devices en route during transmission.

Transactions could be used to push logic flow from the Internet to the sensor pack so that the sensor pack is capable of performing some of the logic that would normally be executed on the servers. This could lead to a more distributed computing model for systems based on the “Internet of Things” architecture as described herein. Sensor packs could be used to manipulate robots or perform other actions within products for a number of reasons. One could be for product maintenance. Another could be for product execution, such as running a dishwasher at a scheduled time, or turning on and off lights in a warehouse.

An additional gateway/router design could implement a “long range” wireless transmission protocol such as cellular, satellite, or other communications protocol that would not be considered “short range” or “mid range”, in addition to previously mentioned designs in this and previous filings referenced above. This would be done to wirelessly backhaul data transmissions to the Internet or have the Internet enabled system send transmissions to the gateway/router via a wireless “long range” transmission protocol.

The “Edge” is the IoT front-line of where technology intersects with business and people, capturing raw data used by the rest of the IoT system. Data is captured by embedding sensors in consumer devices (i.e. fitness trackers, thermostats) appliances or industrial systems (i.e. heating & cooling systems, factory automation) or more specialized applications such as remotely monitoring food temperature and humidity. Such devices can be referred to in this discussion as “Sensor Devices”. Data can then be passed to a “Router” and/or “Gateway” or other “Aggregation Points” that can provide some basic data analytics (parsing raw data) before being sent to the IoT Platform via an Internet connection and beyond. “Routers” can be thought of as local grid or mesh networks whereby implementations such as Bluetooth, Zigbee, WiFi, ANT, OpenWare, LoRa, Sigfox, or other short to mid range wireless transmissions are used to communicate between Sensor Devices and Gateways. Gateways can be thought of as Internet-enabled hardware devices (usually through a wireless WiFi, cellular based such as GSM, CDMA, or other mobile phone carrier network, or landline connection) that communicate either directly to sensors, to sensors through Routers, or a hybrid of both Routers and sensors directly to allow for data to be passed bi-directionally to an Internet platform such as a cloud computing environment or computer network. Also, IoT is not just about capturing data but can also alter the operation of a device with an actuator or other configurable components.

The functionality, shape and size of “Edge” devices are mostly limited by human imagination since most of the technology already exists. For systems including a large number of devices or sensors, gateways and aggregation points serve as the primary connection point with the IoT platform and can collect and prepare data in advance sending the data to the IoT Platform.

### “Edge” Key Components

Environment: This is the operating environment of the sensor or device including natural environments (i.e. outside) or man-made (i.e. buildings, machinery or electronic devices). The environment is important when selecting the sensor to ensure it can withstand the ongoing demands of the environment in addition to power management and maintenance considerations of the “Edge” components.

Sensors: This is where the collection of IoT data begins. In most cases the raw data is analog and is converted to a digital format and sent through a serial bus (i.e. I2C) to a microcontroller or microprocessor for native processing. Typical sampling rates for sensors are 1,000 times per second (1 kilohertz) but can vary widely based on need.

Devices or “Things”: Sensors are typically embedded within existing devices, machines or appliances (i.e. wind turbines, vending machines, etc.) or in more complex systems such as oil pipelines, factory floors, etc. To eliminate sensors just sending a copious amount of raw data, some of these devices have basic analytical capabilities built-in, which allow for some basic business rules to be applied (i.e. send an alert if the temperature exceeds 120 degrees Fahrenheit), as opposed to just sending a live data stream.

Routers: A router broadcasts a radio signal that is comprised of a combination of letters and numbers transmitted on a regular internal of approximately 1/10^{th} of a second. They can transmit at this rate, but in an “intelligent” hardware scenario (Intelligent Sensors and/or Routers) the transmission will likely be much slower, as in 5-10 second intervals or exception based as needed. The term “Intelligent” simply means that there is application logic via software and/or firmware that may provide some logic or filtering of sensor data so that transmissions are only sent when conditions are met or a change in sensor data warrants an update to the network. Routers provide an added dimension “Edge” computing with the ability to combine the location of either Bluetooth, WiFi, Zigbee, ANT, OpenWare, LoRa, Sigfox, or other short or mid-range wireless communication protocol equipped mobile devices (i.e. customers) and/or wired devices along with other factors such as current environmental and weather conditions. For example, by tracking the location of devices, more context relevant information can be pushed to the device such as special offers and recommendations based current conditions.

Aggregation Point or Gateway: The Gateway or Aggregation Point is the final stop before data leaves the “Edge”. While deploying a gateway is optional, it is essential when creating a scalable IoT system and to limit the amount of unneeded data sent to the IoT platform. Key functions include:
Convert the various data models and transport protocols used in the field, such as Constrained Application Protocol (CoAP), Advanced Message Queuing Protocol (AMQP), HTTP and MQTT, to the protocol(s), data model and API supported by the targeted IoT platform. The HTTP/HTTPS and MQTT are what the gateways will talk to the IoT Platform with. Other local protocols like serial, Zigbee, Bluetooth, WiFi, LoRa, Sigfox, cellular, satellite, and/or OpenWare will normally be used from Router to Gateway.
Data consolidation and analytics (“Edge analytics”) to reduce the amount of data transmitted to the IoT platform so network bandwidth is not overwhelmed with meaningless data. This is especially critical when IoT systems include thousands of sensors in the field.
Real-time decisions that would take too much time if the data was first sent to the IoT Platform for analysis (i.e. emergency shut-down of a device).
Send data from legacy operational technology that may not have the ability to send data to an IoT platform.

### Design Considerations

When thinking about the technology and design for the “Edge” of an IoT solution, business requirements are more important here than the technology itself, so IT personnel will have to work closely with the business to identify and meet the functionality, costs and security requirements. Once these business requirements are clearly understood does the technology selection process begin (i.e. sensors, gateways and design). At the same time, IT brings insights into the potential and capabilities provided by IoT technology which can help drive use case scenarios so collaboration between the business and IT is essential.

After defining the business requirements and the focus has shifted to the technical design of an IoT solution, it is important to first explore any unused IoT infrastructure already built into existing machinery, hardware and software (“Brownfield Opportunity”). There are many types of devices and machines out there already equipped with sensor type technology that is simply waiting to be tapped into. This is the low-hanging fruit that can be quickly leveraged with minimal disruption to the business because the technology has already been adopted while helping accelerate IoT initiatives. The “Greenfield Opportunity” is for IoT opportunities in enterprise environments where no existing IoT infrastructure exists.

There are two major deployment options for “Edge” devices used in an IoT solution:
“Edge” deployment without aggregation
“Edge” deployment with a gateway or aggregation point

No Aggregation: Every device is connected to a network (usually the Internet or other IP based system) enabling the device to send and receive data directly to the IoT Platform. This means each device must have a dedicated network and the ability send and receive data using APIs, the data model and transport protocol required by that IoT platform. The device must also have enough computing power for some analytics and to make real-time decisions such as turning off machine if the temperature passes a specified threshold. Finally, the device must have some sort of user interface for maintenance and ongoing updates.

Non-aggregated designs work best when there are few other devices in the area competing for connectivity. Usually, these devices also have more processing power, memory and an operating system capability so it is easier to add or adjust functionality. However, this added device capability is typically more expensive to implement and non-aggregated designs typically don't scale well with each device requiring individual attention to maintain and secure (unless the IoT Platform provides scalable “Edge” device management). Another potential challenge to consider is if the device does not support the IoT platform's transport protocol. In such cases, additional code will need to be added to each device so support the required APIs, data model and transportation protocol.

Aggregation: This design model includes a gateway or some other type of aggregation point connecting “Edge” devices and the IoT platform. Aggregation designs are ideal for IoT implementations with a large number of sensors, a fleet of devices and where the devices are fixed and localized deployments. This is especially true for scaling and consolidating device management where multiple endpoints can be managed from a single location. Using gateways and other aggregation points in an IoT design allows for cheaper sensors and devices with less computing power while allowing for integration with legacy operational technology that otherwise may not have been available. Gateways can also consolidate the various protocols, data models and APIs from the various end points to the standards required by the IoT platform while also providing a location before data reaches the IoT platform for additional intelligence and intelligence to reduce the amount of data sent to the platform.

However, aggregated designs also provide another layer of complexity into the design by adding gateways or other aggregation points. This essentially means another link in the chain that needs to be monitored and addressed when there are issues. Additionally, without built-in redundancy into the design, this could also lead to a single point of failure when a gateway device goes down and all of the connected devices have no way of communicating with the IoT platform. As a result, all aggregation points must be designed with built-in redundancy.

Sensors: IoT sensors are basically a monitoring or measuring device embedded into machine, system or device with an API enabling it to connect and share data with other systems. However, sensors can create copious amounts of data which may have no practical value so analytics or exception based models are applied to reduce it to more of a meaningful dataset before transmission. Data is typically transmitted via an IEEE 802.1 network using an Internet Protocol (IP) to a gateway, router, receiver or aggregation point. The transmission frequency can be real-time streaming, exception-based, time intervals or when polled by another system.

The IoT sensor market is divided into two broad categories. Original Device Manufacturers (ODMs) and Original Equipment Manufacturers (OEMs). ODMs design manufacture the core sensor technology (pressure, temperature, accelerometers, light, chemical, etc.) with over 100,000 types of sensors currently available for IoT solutions. These sensors typically do not include any of the communication or intelligence capabilities needed for IoT solutions so OEMs embed ODM sensors into their IoT devices while adding the communications, analytics and other potential capabilities needed for their specified markets. For example, an OEM who builds a Building Automation IoT application may include various sensor types such as light (IR or visual), temperature, chemical (CO2), Accelerometer and contact.

The ODM marketplace is more consolidates and primarily includes established microelectronics and micro processing incumbents who already have the manufacturing facilities and market share such as ST Microelectronics, IBM, Robert Bosch, Honeywell, Ericsson, ARM Holdings and Digi International. On the flip side, the OEM marketplace more of the Wild West. It includes some of the industry heavyweights but is full of a new generation of startups seeking to capitalize on the IoT market. For example, we have Intel, Fujitsu, Hitachi and Panasonic, in addition to a slew of smaller companies such as Lanner, iWave, Artik, and Inventec. The scope of this paper does not include an in-depth analysis of the ODM and OEM vendor landscape.

Baseline requirements when selecting a sensor device: security (physical, firmware, data, transmission); power management (battery life, recharge ability); analytical capability (Sensors or devices producing large amounts of data or IoT systems using a large number of sensors will need to have analytical capability on the “Edge” to filter and select which data will be transmitted to the IoT Platform and beyond. Without “Edge” Analytics, the sheer volume of data can overload networks, create exorbitant communications costs and generate so much data that it becomes very difficult for it meaningful. Additional analytics will happen at the IoT Platform and enterprise applications using the data.), exception based reporting; communication protocols; wireless API; device maintenance requirements.

Gateways/Routers/Sensor Devices: Information from the “Edge” sensors can be integrated through an Internet enabled platform like an “IoT Platform” such as Microsoft's Azure IoT Platform to perform various services for the customer. Such services could also be integrated into a company's Enterprise Resource Planning or Customer Resource Management software to perform additional services such as scheduling a service call for a failing home appliance or notifying technical support that a particular robotic arm on a manufacturing floor is not operating correctly.

The “Edge” tier of an IoT architecture should consider using an application tier protocol for communicating with servers in an IoT Platform via a standard such as IoTivity from the Open Connectivity Foundation, the AllJoyn Framework from the AllSeen Alliance, or any other IoT specific protocol for application architecture. Such protocols will allow for Sensor Devices to be registered with an IoT Platform and then have them communicate one way or bi-directionally with the IoT Platform during operation. The “Edge” tier can also be integrated into a Device Manager service on the IoT Platform tier so that Sensor Devices, Routers, and/or Gateway Devices can be observed and managed on the IoT architecture. This will provide availability support so that all devices utilized on the “Edge” tier of the IoT architecture can be monitored and serviced as needed.

“Edge” as a Service: The entire “Edge” tier of an IoT architecture can be provided as a bundled service to ease the decision-making process in purchasing an “Edge” computing tier. The concept of providing the “Edge” tier as a bundled service is in itself an entirely new concept and business model since the “Edge” tier of an IoT architecture has just been defined as of this year (2016). This new business and technology model will be referred to as “Edge As A Service” or EAAS for short, and is in the process of being registered as a Service Mark with the United States Patent and Trademark Office. The basic concept is to allow a customer who wants to purchase and utilize an IoT “Edge” tier to have them choose the entire “Edge” tier at one time and have it provided to them as a service by which they will may periodic payments for utilization.

The OpenWare wireless mid-range protocol has been enhanced to be more power efficient than other short range wireless protocols such as Bluetooth, Zigbee, ANT and other short range wireless protocols. One such enhancement is to send the body or raw data from the sensor along with the initial wakeup request on the network so that the relevant sensor data is sent in the initial transmission sequence along with the wakeup indication to initiate a transaction. This should require that the sensor data also be encrypted and/or obfuscated so that sensitive information cannot be intercepted during transmissions.

The OpenWare Sensor Device, Router and Gateway hardware is further enhanced so that sensors such as temperature, pressure, accelerometer, or any other sensor can be remotely calibrated wirelessly. This calibration is a key differentiator as no other Sensor Devices currently support remote calibration of the sensors on-board. These capabilities are in addition to features of the OpenWare product line mentioned in previously filed disclosures as well as in the hardware/sensor configurations listed below:

OpenWare Sensor Device Options (SD-Sensor type): Capable of monitoring ID and sensor readings with battery condition, reporting any changes at a preprogrammed time interval. These sensor packs are able to “send” data (transmitter) to the OpenWare Intelligent Routers and/or Intelligent Gateways for forwarding to either the Local host, Intranet or Internet database via IoT Platform. All models are available with a non-rechargeable coin cell battery offering 400 hours of continuous use, or with a rechargeable battery offering 250 hours of continuous use in the same form factor. All device options have a standard transmission range of 2000 feet line on wireless range with a four-phase commit per transmission to guarantee delivery.

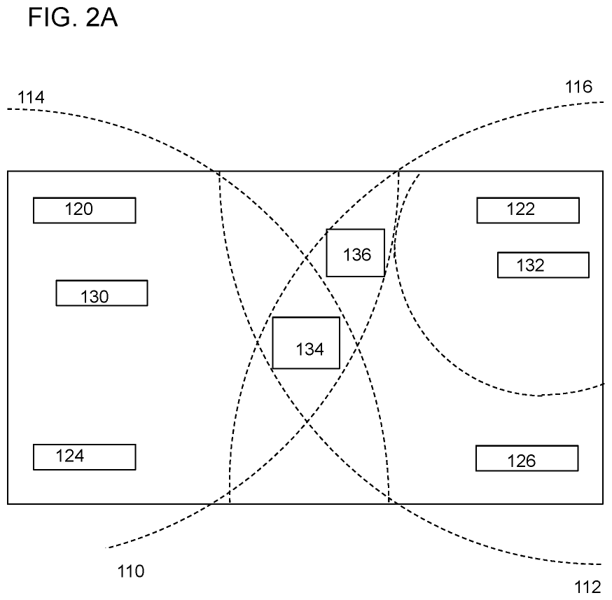

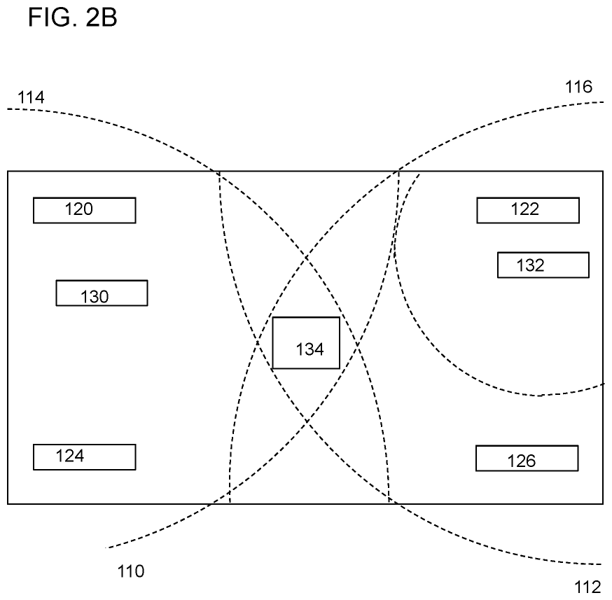

FIG. 2A shows an example “Internet-of-Things” hardware layout for a factory floor with edge hardware including sensor devices 130 and 132; edge routers 120, 122, 124, and 126; and an edge gateway 134 with cellular, satellite and/or LoRaWAN or SigFox capability built in for Internet access. The dashed lines 110, 112, 114, and 116 represent the range of edge routers 120, 122, 124, and 126 respectively. FIG. 2B shows an example “Internet-of-Things” hardware layout for a factory floor with edge hardware including sensor devices 130 and 132; edge routers 120, 122, 124, and 126; and an edge gateway 134 with local WiFi gateway 136 for Internet access.

### Application of Blockchain to Carbon Credit Trading

The global energy crisis requires action to reduce or reverse the rate of negative environmental impact. The creation and trade of carbon credits is a system to track and regulate emissions, incentivizing carbon producers to innovate and adopt green-energy practices. A carbon credit is a generic term for any tradeable certificate or permit representing the right to emit one ton of carbon dioxide or the mass equivalent of another greenhouse gas. Raising the price of carbon credits will incentivize companies to find the most cost-effective ways of reducing their emissions by giving a monetary value to the cost of polluting the air. Emissions become an internal cost of doing business and are visible on the balance sheet alongside raw materials and other liabilities. China, Europe and area of the United States already have their own carbon markets. However, the variance and voluntary nature of existing markets is slowing standardization of carbon credit adoption. What is needed is an automated, globally accessible platform for the tracking and trading of carbon credits. Blockchain technology provides an ideal platform for the carbon market.

The basic aspect of merging carbon credits with a live trading market is that the verification/validation process only has to be done once as the smart contract of a blockchain can be tailored to model the verification from the certification of the verification process on so that the verification process cannot be compromised. In doing so, the carbon credits generated don't have to be questioned as they are already confirmed as accurate. Then the carbon credits can be traded without question as to accuracy and/or authenticity.

Consolidation and optimization of existing carbon markets through migration to our proposed cryptocurrency model would allow utilities and consumers to sell and purchase carbon credits at maximum value using real-time pricing data across all regions. Utilities will able to submit their carbon credits to the market place through smart contracts and automation built into the This Cryptocurrency Model platform.

Measurements for carbon-based allowances or offsets can be calculated and stored in a blockchain based architecture. In the case that the carbon-based measurements (renewable, efficiency, water, etc.) are stored in a blockchain, then that same or an additional blockchain implementation can provide what is referred to as a “cryptocurrency” based on the carbon values provided. In other words, in this mechanism, a “cryptocurrency” can be “backed by” carbon based certificates, credits, or any other form of carbon instrument.

What this will facilitate is the usage of a cryptocurrency that will be instituted by carbon savings, and may support reinvestment of associated profits, residuals, or other means of monetization into additional mechanisms that encourage or accelerate adoption of environmentally efficient practices. Any market that subscribes to this business model must require some of the profits to be directly and/or indirectly invested into projects that could potentially deliver renewable energy or energy efficiencies into actual use, or may introduce energy efficient methods into commercialization in the future.

To expand on the concept, this blockchain may allow for valuations such as BitCoin to be generated by computing processes involving algorithms, but the same platform/market may also allow for creation of valuations that may represent valuations on the same market that may be created by entities producing renewable energy and/or energy efficiencies in the energy market. This merging of existing carbon instruments with cryptocurrency instruments can introduce an entirely new financial market that allows for digital currency and energy efficiency to benefit from, assimilate to, and profit with each other moving forward.

One possible strategy could be for every cryptocurrency unit that is processed, or “mined”, on this carbon-associated market, then a percentage of the currency is dedicated to achieving carbon efficiencies. This could be augmented by participating entities that are reducing carbon usage or producing renewable energy by allowing their activities to also produce cryptocurrency units in an equivalent monetary value, or in a scale that is deemed fair in relation to the cryptocurrency markets. Other models may include purchasing cryptocurrency but specifying a percentage of the purchase go towards energy efficiency efforts. Another could simply have an agreed to purchase or ongoing valuation of the cryptocurrency unit automatically being utilized at a time specified by the instrument, market, seller or buyer to be utilized in carbon reduction. In doing so, this mechanism would elevate both the cryptocurrency market and the carbon market in potential value, ownership, and interest.

Another possible strategy could be for the producer of the renewable energy/carbon allowance, credit or certificate to allow a partial value of that effort to go towards “backing” or endorsing a cryptocurrency unit. This would allow for the carbon market benefits to be realized in the cryptocurrency market. In other words, when a cryptocurrency unit is created, it is directly and/or indirectly attached to a carbon reduction benefit. Alternately, when a carbon offset, allowance, or credit is generated by the energy provider/consumer, that carbon instrument can automatically be converted to a cryptocurrency unit in part or in full to realize monetization.

The monetization of carbon allowances, offsets, credits, and certificates has been historically an obscure process involving registries alongside carbon markets that have implemented a variety of trading barriers. By monetizing carbon benefits in this manner and attaching them to cryptocurrencies in any of the above-mentioned strategies or otherwise, the move to reduce carbon emissions will be dramatically accelerated.

There is a notion of a carbon “registry”, whereby Greenhouse Gas (GHG) Emissions Programs are registered per ISO 14064 and ISO 14065 standards. These “registries” can also be integrated into the aforementioned blockchain architecture. Although they can also be maintained outside the blockchain, it is recommended that any future carbon registry be implemented on a blockchain to increase security, reduce volatility and fraud, as well as maintain a consistent data storage mechanism. If a carbon registry were to implement its storage on a blockchain, it could ensure no replication of carbon certificates/allowances/credits are issued, as well as ensure no fraudulent records are produced.

The current carbon registries allow entities to register GHG emissions programs, and if approved, from approval date on the registries allow the entities that own or manage the GHG emissions program to receive carbon certifications, allowances, offsets, credits, etc. based on future efficiencies or renewable power production. There is no guarantee that the future carbon certifications, allowances, offsets, credits, etc. are valid as most participants submit billing statements, monthly reports, etc. to verify power usage. This is not exact or precise in any way and can create fraudulent practices. The recommended mechanism after a GHG emissions program is approved is to have some form of electronic wattage or water usage meter that can automatically transmit data on a standardized interval up to an Internet enabled network, preferably a Cloud-based data storage facility. To improve the accuracy and security of the data being transmitted, it should be encrypted from the measurement device all the way to the data storage facility. To further improve the integrity of the system, the data storage facility should be based on a blockchain implementation as that would implement an “immutable” data storage implementation on the Cloud. Regardless of what storage implementation is used, the “registry” as well as the data storage implementation used to back up the metering devices should be an “immutable” data storage facility. In other words, all aspects of the aforementioned system as well as the implementations described in the referenced provisional patent applications filed previously should incorporate data storage facilities that support full data encryption as well as insertion of data that cannot be altered once submitted.

The cryptocurrency model described herein may potentially allow entities that produce renewable energy or energy efficiencies to be issued corresponding cryptocurrency units instead of carbon certificates, allowances, offsets, etc. on a carbon market, or issued carbon instruments that can be converted into cryptocurrency. Or, as an alternate plan, the carbon markets could adopt a more fluid environment much like the cryptocurrency markets have enabled. By linking carbon and cryptocurrency, the concept allows digital currency to be ensured by carbon offsets. The significance of this is that currently digital currency has no limited-availability commodity associated with it. For instance, most first-world currencies are “backed” by gold, hence the “gold standard”. This means that the currency issued has some physical assurance that it is actually worth something. Although this standard hasn't been fully maintained, the concept still applies. However, no digital currency is backed by any limited resource. It makes a lot of sense to have a digital currency to be endorsed, or “backed” by carbon allowances/certificates/credits/etc. If a digital currency supports an association with carbon reduction, it can potentially accelerate the reduction of fossil fuels. This concept could be referred to as the “carbon standard”.

Another model could be that each cryptocurrency unit that is generated through “mining” or computer processing is done so with the understanding that a certain percentage of it's worth is applied towards reducing carbon emissions in some capacity. This could serve to promote renewable energy production or energy efficiency efforts. The simplification of carbon allowances/certificates/offsets/etc. would be benefitted if they were normalized on both the renewable energy production side as well as the energy efficiency consumption side. If normalized, both the production and consumption side could be represented as a single commodity, or carbon instrument.

In addition to the above models, the carbon instruments can then be converted into a unit of cryptocurrency and stored in a blockchain implementation of any of the variations mentioned in this disclosure. The same blockchain could also support “mining” for cryptocurrency creation similar how to “Bitcoin” works. By supporting creation of cryptocurrency units in a single cryptocurrency market via energy efficiencies and/or renewable or “greener” energy production as well as data mining, this market could allow individuals as well as companies such as utilities to participate in a cryptocurrency market that is designed to promote carbon efficiencies and/or renewable or more environmentally safe energy sources. Some of the proceeds from the sale and/or trade of this type of cryptocurrency could be used to build and maintain renewable energy production facilities like solar and wind farms, or be used to implement energy efficiency programs on buildings in say, for instance, economically challenged geographic areas. This could in turn facilitate additional carbon offset/certificate/allowance production that could be used to generate additional cryptocurrency units for years to come.

Yet another aspect of this cryptocurrency market could be to support at any time the cryptocurrency units being converted back into carbon offsets/certificates/allowances/etc. for use by an entity in achieving carbon reduction goals or to hold as a carbon-based instrument that can later be reconverted back into a cryptocurrency unit. These cryptocurrency units could be referred to as carbon coins, carbon currency, or some similar suitable name that references the association with carbon reduction programs.

By implementing these models for creating and managing a cryptocurrency market, one may in effect eliminate the need for existing carbon markets as they are based on government enforcement of carbon reduction incentivization schemes like cap-and-trade policies as well as similar mechanisms to ensure/promote enforcement by participating companies and/or utilities. These new mechanisms disclosed herein will create incentivization to participate in carbon reduction and clean energy production for the purposes of creating cryptocurrency units that can be immediately and/or actively traded for cash on a cryptocurrency market. By the same notion, people/entities wanting to data mine cryptocurrency can also participate in the same or another dedicated cryptocurrency market that will set-asides and direct investment strategies identified in this disclosure to create new clean energy sources and energy efficiency implementations. These investment strategies may include investment in other inventions that promote clean energy production or energy efficiencies and/or direct construction of new clean energy sources. These investment strategies may include a percentage of the creation and/or trading of the cryptocurrency units themselves from the carbon validation/verification side as well as from the data mining side of the market. This can also be accomplished by two separate cryptocurrency markets, one dedicated to carbon offsetting/reduction efforts while another is dedicated to data mining similar to what “Bitcoin” is performing today.

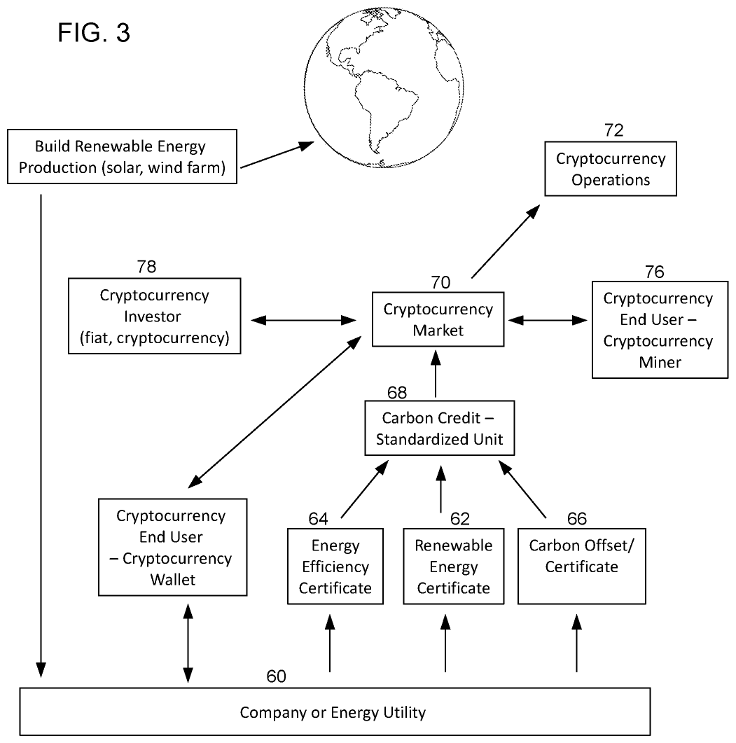

FIG. 3 is an example of the transactions that may occur in the proposed cryptocurrency market. A utility/company 60 produces either a Renewable Energy Certificate (REC) 62, Energy Efficiency Certificate (EEC) 64, or Carbon Offset Certificate 66. This is submitted to the cryptocurrency market 70 as a standardized carbon credit unit 68. The cryptocurrency market 70 issues $20 in cryptocurrency back to the utility/company 60, $40 to the cryptocurrency operations 72, and $40 to a renewable energy account. From there, the renewable energy account can be used to produce renewable energy production facilities, which during operation create renewable energy that can be sold to either a direct energy customer or utility for distribution. Profits from the energy sale go to the renewable energy account for operations/investment into further renewable energy production facility buildout. In addition, the new production facilities also produces more carbon credits, which are submitted back into the cryptocurrency market 70.

An institutional investor 78 can deposit fiat currency or cryptocurrency to the cryptocurrency market 70, and this cryptocurrency is issued at the same U.S. dollar value back to the investor 78. The deposit is leveraged 50% and $50 in cryptocurrency is issued to the renewable energy account. A cryptocurrency miner 76 mines the cryptocurrency market 70 for the cryptocurrency. When the transaction is completed, cryptocurrency is issued to the miner 76. The cryptocurrency is also issued to renewable energy account.

The backbone of this cryptocurrency platform is Hyperledger, a blockchain technology developed to advance cross-industry collaboration with a particular focus on improving performance and reliability for supporting global business transactions by major technological, financial, and supply chain companies. Hyperledger Sawtooth, an application contributed by Intel, uses a “Proof-of-Elapsed Time” (PoET) consensus protocol that builds on trusted executed environments provided by Intel's Software Guard Extensions. Using a PoET mining model reduces the cost per transaction to pennies, which is miniscule compared to existing “Proof-of-Work” (PoW) or “Proof-of-Stake” (PoS) cryptocurrencies and traditional trusted third-party systems. The design pattern for mining is done by the Sawtooth Batch Injector interface. More information about Hyperledger Sawtooth can be found at: https://sawtooth.hyperledger.org/docs/core/releases/latest/contents.html

In the exemplary proposed modified blockchain implementation dedicated to carbon credit generation and monetization, the process works like below:

1. IoT device or other measurement equipment sends relevant data to the blockchain, which is immediately committed after a technical review to confirm that the data is valid and from the intended source.

2. The blockchain may implement through a smart contract, simple vault, direct messaging, or some other design to contact a carbon credit verification body on a timed interval to calculate carbon credits.

3. The verification body may act on its' own to access the blockchain on intervals to calculate carbon credits as needed.

4. This could mean that the verification body is responsible for committing the data transmitted by the IoT device in a real-time manner, on a timed interval, or otherwise. What is most important is that the verification body is responsible for reviewing data sent by IoT devices under its authority, assignment, or management. In doing so, only valid data from IoT devices should be validated and/or verified for use in carbon credit calculations.

5. Once the verification body calculates carbon credits/allowances/offsets/etc. and registers them in the same or another blockchain, the carbon credits/allowances/offsets/etc. can be submitted to a carbon trading market for trade or purchase.

6. The blockchain implementation should be able to perform this from a single blockchain ledger, or multiple that are congruent to each other. In doing so, the implementation overall can maintain integrity, security, authenticity, and accuracy in trading the carbon credits/allowances/offsets/etc.

So, the rules for the scenario mentioned are as follows:

1. IoT devices should be registered and verified by a blockchain before allowing the devices to participate in communication with the blockchain.

2. Once devices are registered for use by a given blockchain, they can begin to transmit data to the blockchain as logic on the IoT device allows.

3. As a transmission is sent to the blockchain, it should be fully encrypted en route.

4. Once received by the blockchain, the data should be committed.

5. The data should be available initially only to the assigned verification body for analysis.

6. Once the verification body has analyzed the data, it should confirm that the data is valid and is used in calculation of carbon credits/allowances/offsets/etc.

7. After the verifier calculates carbon credits based on a given set of data, then the carbon credits/allowances/offsets/etc. should be submitted to a market for purchase or trade, either in real time, on a scheduled interval, or on scheduled times.

Proof-of-Elapsed Time (PoET): PoET is a low energy mining and transaction verification model developed by Intel used by Hyperledger Sawtooth. Proof of Elapsed Time is secure, and uses significantly less electricity per transaction compared to existing PoW and PoS models. Proof of Elapsed Time assigns each participant in the blockchain network a random amount of time to wait. The first participant to finish waiting gets to be leader for the new block. This eliminates the need for nodes to produce work as proof of participation, and since nodes will be assigned their wait time from a Trusted Execution Environment (TEE), this process is highly secure.

At a high-level, PoET stochastically elects individual peers to execute requests at a given target rate. Individual peers sample an exponentially distributed random variable and wait for an amount of time dictated by the sample. The peer with the smallest sample wins the election. Cheating is prevented through the use of a trusted execution environment, identity verification and blacklisting based on asymmetric key cryptography, and an additional set of election policies.

The process of PoET is as follows. A new participant downloads trusted code for the blockchain. When executed, the trusted code creates a new keypair. The new participant sends a certificate created from the Trusted Execution Environment to the network as a join request. The new participant obtains a signed timer object from the trusted code and waits the specified time from their assigned timer object. The trusted code's private key sends a certificate to the participant when the timer has completed. The participant relays the certificate to the rest of the network along with new block information.

Another mining mechanism could be to model after existing PoW mechanisms or algorithms to earn cryptocurrency but modify the mechanism so that it only requires a small portion of the timeframe required to complete a unit of work to actually be spent processing an algorithm to earn cryptocurrency. This would reduce the amount of electricity needed to process a unit of work than current PoW mining techniques require. The mining software itself can restrict how much time the computer spends actually processing an algorithm to complete a scope of work over the timeframe allocated to process the transaction or complete the work required to earn cryptocurrency. The calculation for crediting a mining rig for processing in this manner could award the amount of cryptocurrency awarded to be based on the overall processing capabilities of the underlying hardware so that mining rigs can get compensated accordingly. This mechanism could be implemented using some of the PoET features above including the wait timers so that the mechanism is secure and can't be defrauded easily ensuring accuracy and validity of this mining mechanism. Computer equipment mining for cryptocurrency in this mechanism do not have to maintain online access the entire time they are being used for this mining mechanism and can even be turned off and back on without interrupting or changing the time required to process a unit of work. This mining mechanism may or may not allow a user to use the computing device or mining rig for other purposes during the timeframe needed to process a single unit of work.

As an overall example of the mining mechanism above, consider the following steps:

1. Participant decides to use their computing equipment to earn cryptocurrency.

2. Participant installs software that can manage the units of work being processed to earn cryptocurrency.

3. Participant contacts cryptocurrency-related system that provides a single unit of work to the participant.

4. The software then initiates the unit of work by creating a Create Timer, Time to Process, Time to Finish, and a Check Timer in the TEE environment on the local computing device.

5. The Check Timer runs while the software processes the algorithm for the cryptocurrency-related system. At some point, the Time to Process is reached and the software stops processing the algorithm. Then the software is at rest and no more electricity is used by the host computer for this mining mechanism except what it takes to keep the Timers running or perform other unrelated computing efforts.

6. Occasionally, the Check Timer will check to see if the Time to Finish threshold has been reached.

7. Once the Check Timer reaches the Time to Finish, the unit of work is completed and the software contacts the cryptocurrency-relates system to register that the unit of work was completed, and cryptocurrency is issued to the Participant for their efforts.

### One-Time Pad for Blockchain Encryption

In cryptography, the one-time pad (OTP) is an encryption technique that cannot be cracked, but requires the use of a one-time pre-shared key the same size as, or longer than, the message being sent. In this technique, a plaintext is paired with a random secret key (also referred to as a one-time pad). Then, each bit or character of the plaintext is encrypted by combining it with the corresponding bit or character from the pad using modular addition. If the key is truly random, is at least as long as the plaintext, is never reused in whole or in part, and is kept completely secret, then the resulting ciphertext may be impossible to decrypt or break. It has also been proven that any cipher with the perfect secrecy property must use keys with effectively the same requirements as OTP keys. However, practical problems have prevented one-time pads from being widely used. The “pad” part of the name comes from early implementations where the key material was distributed as a pad of paper, so that the top sheet could be easily torn off and destroyed after use.

Example: Suppose Alice wishes to send the message “HELLO” to Bob. Assume two pads of paper containing identical random sequences of letters were somehow previously produced and securely issued to both. Alice chooses the appropriate unused page from the pad. The way to do this is normally arranged for in advance, as for instance “use the 12th sheet on 1 May”, or “use the next available sheet for the next message”. The material on the selected sheet is the key for this message. Each letter from the pad may be combined in a predetermined way with one letter of the message. (It is common, but not required, to assign each letter a numerical value, e.g., “A” is 0, “B” is 1, and so on.)

In this example, the technique is to combine the key and the message using modular addition. The numerical values of corresponding message and key letters are added together, modulo 26. So, if key material begins with “XMCKL” and the message is “HELLO”, then the coding would be done as follows:

| | | | | | | |
|---|---|---|---|---|---|---|
| | H | E | L | L | O | message |
| | 7 (H) | 4 (E) | 11 (L) | 11 (L) | 14 (O) | message |
| + | 23 (X) | 12 (M) | 2 (C) | 10 (K) | 11 (L) | key |
| = | 30 | 16 | 13 | 21 | 25 | message + key |
| = | 4 (E) | 16 (Q) | 13 (N) | 21 (V) | 25 (Z) | (message + key) |
| | | | | | | mod 26 |
| | E | Q | N | V | Z | ciphertext |

If a number is larger than 26, then the remainder after subtraction of 26 is taken in modular arithmetic fashion. This simply means that if the computations “go past” Z, the sequence starts again at A. The ciphertext to be sent to Bob is thus “EQNVZ”. Bob uses the matching key page and the same process, but in reverse, to obtain the plaintext. Here the key is subtracted from the ciphertext, again using modular arithmetic:

| | | | | | | |
|---|---|---|---|---|---|---|
| | E | Q | N | V | Z | ciphertext |
| | 4 (E) | 16 (Q) | 13 (N) | 21 (V) | 25 (Z) | ciphertext |
| − | 23 (X) | 12 (M) | 2 (C) | 10 (K) | 11 (L) | key |
| = | −19 | 4 | 11 | 11 | 14 | ciphertext − key |
| | 7 (H) | 4 (E) | 11 (L) | 11 (L) | 14 (O) | (ciphertext − key) |
| | | | | | | mod 26 |
| | H | E | L | L | O | message |

Similar to the above, if a number is negative then 26 is added to make the number zero or higher. Thus Bob recovers Alice's plaintext, the message “HELLO”. Both Alice and Bob destroy the key sheet immediately after use, thus preventing reuse and an attack against the cipher. The classical one-time pad of espionage used actual pads of minuscule, easily concealed paper, a sharp pencil, and some mental arithmetic. The method can be implemented now as a software program, using data files as input (plaintext), output (ciphertext) and key material (the required random sequence).

The XOR operation is often used to combine the plaintext and the key elements, and is especially attractive on computers since it is usually a native machine instruction and is therefore very fast. However, it is difficult to ensure that the key material is actually random, is used only once, never becomes known to the opposition, and is completely destroyed after use. The auxiliary parts of a software one-time pad implementation present real challenges: secure handling/transmission of plaintext, truly random keys, and one-time-only use of the key.

Attempt at cryptanalysis: To continue the example from above, suppose Eve intercepts Alice's ciphertext: “EQNVZ”. If Eve had infinite time, she would find that the key “XMCKL” would produce the plaintext “HELLO”, but she would also find that the key “TQURI” would produce the plaintext “LATER”, an equally plausible message:

| | | | | | | |
|---|---|---|---|---|---|---|
| | 4 (E) | 16 (Q) | 13 (N) | 21 (V) | 25 (Z) | ciphertext |
| − | 19 (T) | 16 (Q) | 20 (U) | 17 (R) | 8 (I) | Possible key |
| = | −15 | 0 | −7 | 4 | 17 | ciphertext − key |
| | 11 (L) | 0 (A) | 19 (T) | 4 (E) | 17 (R)) | (ciphertext − key) |
| | | | | | | mod 26 |
| | L | A | T | E | R | message |

In fact, it is possible to “decrypt” out of the ciphertext any message whatsoever with the same number of characters, simply by using a different key, and there is no information in the ciphertext which may allow Eve to choose among the various possible readings of the ciphertext.

Conventional symmetric encryption algorithms use complex patterns of substitution and transpositions. For the best of these currently in use, it is not known whether there can be a cryptanalytic procedure that can reverse (or, usefully, partially reverse) these transformations without knowing the key used during encryption. Asymmetric encryption algorithms depend on mathematical problems that are thought to be difficult to solve, such as integer factorization and discrete logarithms. However, there is no proof that these problems are hard, and a mathematical breakthrough could make existing systems vulnerable to attack.

Given perfect secrecy, in contrast to conventional symmetric encryption, OTP is immune even to brute-force attacks. Trying all keys simply yields all plaintexts, all equally likely to be the actual plaintext. Even with known plaintext, like part of the message being known, brute-force attacks cannot be used, since an attacker is unable to gain any information about the parts of the key needed to decrypt the rest of the message. The parts that are known may reveal only the parts of the key corresponding to them, and they correspond on a strictly one-to-one basis; no part of the key is dependent on any other part.

Key Distribution: Because the pad, like all shared secrets, must be passed and kept secure, and the pad has to be at least as long as the message, there is often no point in using one-time padding, as one can simply send the plain text instead of the pad (as both can be the same size and have to be sent securely). However, once a very long pad has been securely sent (e.g., a computer disk full of random data), it can be used for numerous future messages, until the sum of their sizes equals the size of the pad. Quantum key distribution also proposes a solution to this problem.

Distributing very long one-time pad keys is inconvenient and usually poses a significant security risk. The pad is essentially the encryption key, but unlike keys for modern ciphers, it must be extremely long and is much too difficult for humans to remember. Storage media such as thumb drives, DVD-Rs or personal digital audio players can be used to carry a very large one-time-pad from place to place in a non-suspicious way, but even so the need to transport the pad physically is a burden compared to the key negotiation protocols of a modern public-key cryptosystem, and such media cannot reliably be erased securely by any means short of physical destruction (e.g., incineration). A 4.7 GB DVD-R full of one-time-pad data, if shredded into particles 1 mm² in size, leaves over 4 megabits of (admittedly hard to recover, but not impossibly so) data on each particle. In addition, the risk of compromise during transit (for example, a pickpocket swiping, copying and replacing the pad) is likely to be much greater in practice than the likelihood of compromise for a cipher such as AES. Finally, the effort needed to manage one-time pad key material scales very badly for large networks of communicants—the number of pads required goes up as the square of the number of users freely exchanging messages. For communication between only two persons, or a star network topology, this is less of a problem.

The key material must be securely disposed of after use, to ensure the key material is never reused and to protect the messages sent. Because the key material must be transported from one endpoint to another, and persist until the message is sent or received, it can be more vulnerable to forensic recovery than the transient plaintext it protects (see data remanence).

Authentication: As traditionally used, one-time pads provide no message authentication, the lack of which can pose a security threat in real-world systems. For example, an attacker who knows that the message contains “meet jane and me tomorrow at three thirty pm” can derive the corresponding codes of the pad directly from the two known elements (the encrypted text and the known plaintext). The attacker can then replace that text by any other text of exactly the same length, such as “three thirty meeting is canceled, stay home.” The attacker's knowledge of the one-time pad is limited to this byte length, which must be maintained for any other content of the message to remain valid. This is a little different from malleability, where it is not taken necessarily that the plaintext is known. See also stream cipher attack.

Standard techniques to prevent this, such as the use of a message authentication code can be used along with a one-time pad system to prevent such attacks, as can classical methods such as variable length padding and Russian copulation, but they all lack the perfect security the OTP itself has. Universal hashing provides a way to authenticate messages up to an arbitrary security bound (i.e., for any p>0, a large enough hash ensures that even a computationally unbounded attacker's likelihood of successful forgery is less than p), but this uses additional random data from the pad, and removes the possibility of implementing the system without a computer.

Uses and Applicability: Any digital data storage device can be used to transport one-time pad data. The one-time-pad is the optimum cryptosystem with theoretically perfect secrecy. The one-time-pad is one of the most practical methods of encryption where one or both parties must do all work by hand, without the aid of a computer. This made it important in the pre-computer era, and it could conceivably still be useful in situations where possession of a computer is illegal or incriminating or where trustworthy computers are not available.

One-time pads are practical in situations where two parties in a secure environment must be able to depart from one another and communicate from two separate secure environments with perfect secrecy. The one-time-pad can be used in superencryption. The algorithm most commonly associated with quantum key distribution is the one-time pad. The one-time pad is mimicked by stream ciphers. The one-time pad can be a part of an introduction to cryptography.

True Randomness: The one-time pad can have serious drawbacks in practice because it requires (1) truly random (as opposed to pseudorandom) one-time pad values, which is a non-trivial requirement; and (2) secure generation and exchange of the one-time pad values, which must be at least as long as the message. (The security of the one-time pad is only as secure as the security of the one-time pad exchange).

High-quality random numbers are difficult to generate. The random number generation functions in most programming language libraries are not suitable for cryptographic use. Even those generators that are suitable for normal cryptographic use, including/dev/random and many hardware random number generators, may make some use of cryptographic functions whose security has not been proven. An example of how true randomness can be achieved is by measuring radioactive emissions.

The basic constraint of an OTP implementation is to have a live and continuous source of random data to work with. This can be accomplished by utilizing measurement devices such as Internet-of-Things sensor devices to create random sequences based potentially on sensor input, and then transmit the random data to cloud storage for real-time and/or future use. The easiest example of this could be to measure voltage output from various electrical flows throughout the electrical grid and feed those voltage fluctuations on timed sample rates to a cloud storage database. Other sensor based information that fluctuates randomly over a timed sequence could also be utilized for such an implementation. Perhaps the most random means of sensor measurement could be based on the concept of what most scientists consider truly random sequencing; radioactive decay of isotopes. However, the most readily available source of radiation based on nuclear reaction is sunlight. If solar panels were to transmit frequent sample rates of conduction during hours of sunlight on a regional or global scale, the data stream would be representing nuclear reaction fluctuations consistent with solar radiation and/or nuclear reactions by the Sun. This should create a constantly producing random number sequence that would be non-repeating and in no way reproducible with earth-bound technology. The random number sequence produced in this manner could be stored in an immutable data store such as a blockchain and used in real-time or at a later date to perform cryptographic sequencing for an OTP implementation.

Once random data is collected, it can be used in a One-Time Pad implementation by allowing the data that needs to be secured to be encrypted in a manner consistent with a OTP implementation. Once the data is modified, it can be stored on a blockchain or other ledger and then the OTP key data can be securely sent to the party of interest for decryption at a later time. The corresponding random data used to encrypt the user data should then be deleted from the data store altogether so that the encrypted data can only be recovered by the person that requested the encryption to begin with.

Another implementation of OTP could be to have constantly changing measurements form IoT devices sent to a server or cloud-based environment for use. This constantly changing measurement stream could be generated by measuring the electrical flow from solar panels equipped with highly sensitive measurement equipment. Of course, on a global scale any combination of sensor data could be used to create a random number stream, including solar voltage readings from PV panels, electromagnetic measurements, heat sensors over thermal features such as active volcanos and geysers, or other natural events and occurrences that fluctuate energy release over time and/or the time interval between voltage fluctuations for variance in the data stream.

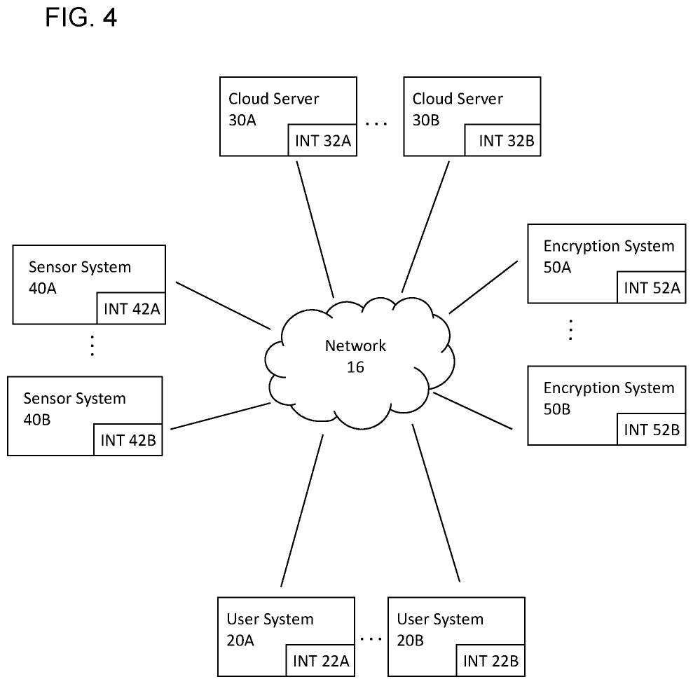

FIG. 4 is a block diagram of a sensor data based encryption architecture according to various embodiments. As shown in FIG. 4, the encryption architecture includes sensor systems 40A, 40B that are coupled to a network 16 via interfaces 42A, 42B. Also included are cloud servers 30A, 30B that are coupled to network 16 via interfaces 32A, 32B. Also included are encryption systems 50A, 50B that are coupled to network 16 via interfaces 52A, 52B. Also included are user systems 20A, 20B that are coupled to network 16 via interfaces 22A, 22B. In an embodiment, any of the aforementioned systems or the cloud servers may be coupled to the network 16 via wired or wireless connections and may be coupled directly to each other via wired or wireless connections. In an embodiment, the sensor system 40A may be part of an IoT architecture as shown in FIGS. 2A and 2B.

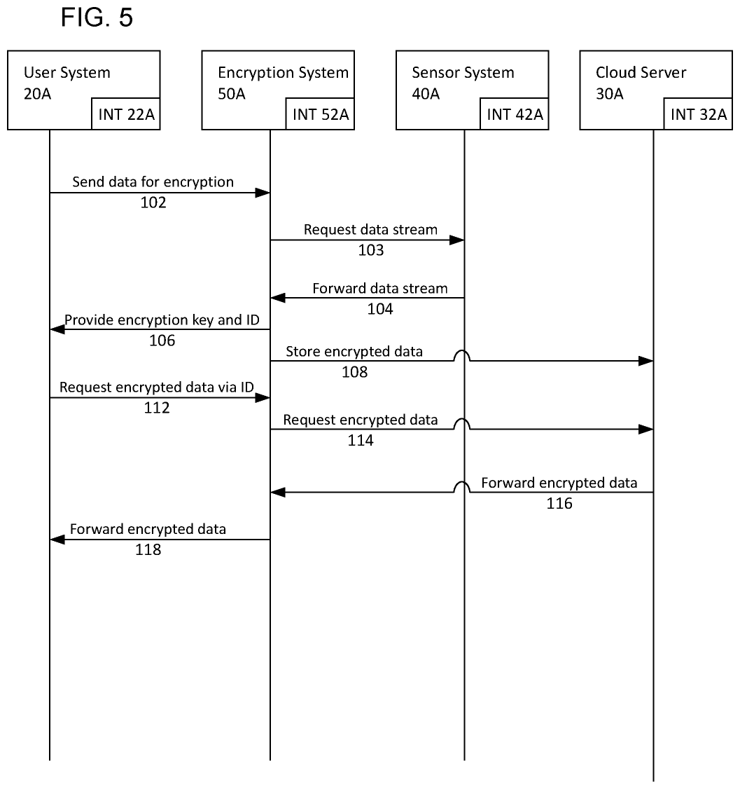

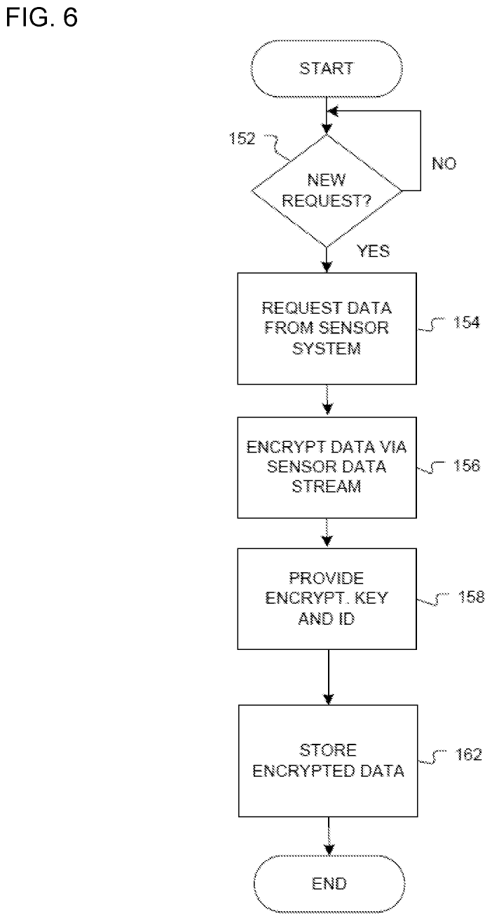

Further in reference to FIG. 5 and FIG. 6 together, in an embodiment, a user (via a user system 20A) may desire to securely encrypt data (activity 152 of algorithm 150 shown in FIG. 6). The user, via their system 20A, may send the data to an encryption system 50A (communication 102 shown in FIG. 5). The encryption system 50A may request or continuously receive random data from a sensor system 40A (communication 103, 104 shown in FIG. 5 and activities 154, 156 shown in FIG. 6). As noted, the sensor data may be random and coupled to a timer that provide an effective ID for the random sensor data, which may form the encryption key and ID for the data that encryption system 50A may encrypt for a user (activity 158 shown in FIG. 6 and communications 106 shown in FIG. 5). The encryption system may store the user encrypted data locally or in a various cloud servers 30A including block chain type systems (activity 162 in FIG. 6, communication 108 in FIG. 5).

In an embodiment, when a user wants to decode their encrypted data they via their system 20A may send the ID for the encrypted data to the encryption system 50A (communication 112 in FIG. 5). The encryption system 50A may retrieve the encrypted data from storage (communications 114, 116 in FIG. 5). The encryption system 50A may then forward the encrypted data to the user device for decoding (communication 118 in FIG. 5). In an embodiment, a user system 20A may provide the ID and encryption key to the encryption system 50A to decode the data. In a further embodiment, the sensor data that forms the encryption key may be forwarded directly to the user system 20A.

Another way to produce a random data stream (least recommended of course) would be to have radioactive isotopes with a fairly long radioactive decay half-life monitored by a Geiger counter and have the time in between the release of electrons recorded and turned into a random data stream. Alternately, a suitable random number stream could be generated from human interaction such as smartphones and computers, or without interaction with computing devices such as smartphones and computers, or any combination of the above. For instance, smartphones can achieve a high degree of ongoing random number generation from the barometric pressure, magnetic field, and inclination sensors without human interaction. With human interaction, the variations become more sophisticated. The random number stream could be constantly transmitted over a network, possibly encrypted with SSL, TLS, or SSL over web sockets, to a server or cloud environment. As the random number stream feeds through the server or cloud environment in a constant or burst data segment, it can be utilized at any time for encryption purposes.

Type of Measurements: Measurement types can be categorized by the associated physical properties they represent. Individuals conducting measurements should understand the purpose of the measurement. This section describes these properties and their respective measuring methodologies. The corresponding equipment descriptions are included in a subsequent section.

Electrical: Electric power and energy are typically the most important measurements for savings evaluations. As electric power is commonly a direct measurement of the energy use of a load, it may be the only measurement needed to determine savings between a base case and high efficiency measure. The common unit of power is kilowatts (kW). The common unit of energy is kilowatt-hour (kWh). Energy is power used during a unit of time. Other electrical measurements are voltage (V), current in amperes (A), and power factor (PF). Although direct current voltage (Vdc) is used to power some types of equipment, utility transmission to customers occurs in the form of alternating current voltage (Vac). For this discussion, A and V are expressed in terms of alternating current, and the values measured or recorded are the root mean square (RMS) values. In general terms, RMS is the common presentation of alternating current electrical measurements. Apparent power (V·A) multiplied by the power factor equals the true power (W=V·A·PF).

Power factor is given by the following. For perfect sinusoidal waveforms, the power factor is the cosine of the angle of the phase shift between the current and the voltage. If the voltage and current waveform are non-sinusoidal, the definition of power factor is (V·A)/W. When conducting current metering, additional analysis is needed to convert current data to power data. Harmonics are produced by electronic loads. These non-sinusoidal waveforms can only be accurately measured by meters designed to make true RMS measurements.

Consider the following transaction. An entity wants to encrypt data and have it stored in an immutable ledger for safe storage and later recovery. The entity transmits their data to the server or cloud environment for encrypting and storage. Once the data packet arrives, the server or cloud environment then notes a timestamp of when the message is being encrypted and proceeds to capture as much data is needed to encrypt the user data in an OTP manner. The random number sequence may also be normalized to a clock on the computing environment in that it only records a data measurement for each of the most precise units of time that can be measured by the server or cloud computers. This may ensure that the data sequence stays in order during encryption. It will also allow the encrypted packets to be stored on a ledger and referenced by timestamp as opposed to unique identifier for referencing later. As a possible example, if the user submits a 50 character packet of data for securing, then a 50 or more number sequence needs to be captured in memory from the precise time the encryption request is made to the server or cloud environment. The initial data is encrypted in a manner consistent with OTP encryption methods. If additional data is captured, then it can be used to further encrypt the data with a hash algorithm or pad the data packet with data to further obfuscate the final encrypted packet. Once the data is encrypted, the random sequence used to encrypt the data (which becomes the decryption key) should be sent back to the user in a secure manner, and the encrypted data is written to a ledger with the timestamp of when the encryption sequence started to be used as the label, header, or unique id for the encrypted packet. The timestamp or unique id for looking up the data packet on the ledger at a later time can be sent back during the finalization of the transaction, or through some other form of communication such as text message to a mobile device, email, or some other form of communication.

Think of the transmission of the timestamp or unique ID as a second verification for each transaction, similar to the “two-step verification” process in use at several major banks. When you log into most online email services, you for some time now have had the opportunity to enable two-step verification. The initial transaction will only involve the user initiating the transaction by submitting the record or document for encryption and storage on a ledger. The OTP implementation will encrypt the data, and then send the decryption key back to the user. Then, the unique id to lookup the data will be sent via text message, email or some other form of communication. This should protect the user from most security issues.

More sophisticated lookup schemes can be implemented that may involve a user's username, id, or other forms of identification to assist in securing and retrieving data in this OTP implementation. One important potential design aspect is that the random number stream may never in itself be written to storage unless required to implement the encryption scheme in use. Otherwise, the random number stream should constantly flow to the server or cloud environment to increase security as well as facilitate the OTP scheme. This encrypted ledger system should be constructed in a manner such that the encrypted packet or record should have a lookup id that is unique globally and based on the timestamp of when the encryption started as well as any other identifiable information used to encrypt the data. The ledger storage should then record the encrypted data itself in a manner that is considered immutable and/or untamperable. Of course, this encrypted ledger may differ significantly from a blockchain implementation, whereby each packet contains a hashed address or location of the next block in the chain. This OTP implementation may require that no encrypted data packet has to reference another encrypted data packet. The data packets just have to be searchable from the unique id standpoint for retrieval by the user. Another possible identification mechanism could be to incorporate an IP address into the unique id so that the encrypted packet can be located in a fully distributed computing environment. If each encrypted packet should reference the next packet in the sequence, then some hashing or other mechanism can be incorporated in a manner in which the OTP implementation encrypts not only the user data but additional information that references the next encrypted packet in the ledger.

There are several advantages of this OTP implementation over a blockchain:
1. The OTP encryption calculation is much faster than executing a standard PKI encryption algorithm (AES, 3DES, etc.) over data.
2. OTP is not vulnerable to any dictionary or brute force attacks.
3. The OTP mechanism described herein doesn't store the encryption key server-side so once a transaction is completed, the user knows the key is in their possession exclusively.
4. All other blockchain ledgers have limits on their size. This OTP implementation can increase in size indefinitely without performance degradation.
5. PKI really was not designed to be used in an immutable encrypted ledger model because it isn't a two-way origination of the communication and does not require identification of both parties through third-party authorization (Certificate Authorities) to conduct a transaction. It is just a user of the system and the computing environment where records are stored and retrieved. Therefore, key-pair encryption schemes create unnecessary overhead when compared to OTP implementations.
6. If quantum computers are created in the near future, they could be used to compromise every encryption scheme currently in use, including symmetric and asymmetric encryption schemes currently in use by the cryptocurrency markets. This OTP implementation would eliminate that threat altogether as it is not susceptible to brute force, dictionary attacks or other methods that can be used to break symmetric and asymmetric algorithm encryption schemes.

The notion of a constant stream of random data from sensors and/or Geiger Counters will allow for several major advancements in computing architecture related to secure blockchains as well as cryptocurrency implementations. The above model could also be coupled with a hardware design that supports a write once and read only storage facility. Then the packets of encrypted data can be written into storage with the guarantee that they haven't been altered at any point in the future. Think of CD-R vs CD_RW. Current storage implementations on the Internet that include SCSI drives, SSD drives. If they were manufactured to work like CR-R drives, then encrypted data could be written to them and be guaranteed that they are never altered in the future.

This OTP encryption model also supports the notion of “Encryption as a Service” where any user of the system can choose to encrypt and/or store data on ledger information they believe to be important. This mechanism can also be used in cryptocurrency and/or securities markets to provide the best overall encryption security to users of such systems. Encrypted packets could be linked to each other in a “chain” fashion, but ultimately with OTP encryption to a ledger, encrypted packets don't have to necessarily be “linked” to each other as in most current blockchain implementations. The OTP model will virtually eliminate overhead on electricity needed to participate in creating records or cryptocurrency units on a ledger, while providing the only encryption scheme that has been universally accepted as the only “unbreakable” encryption scheme created to date. Ledgers for this OTP model can be private and/or public based on market requirements. This OTP implementation can benefit payment systems as it would minimize execution time per transaction and dramatically speed up payment processing when compared to current blockchain implementations. OTP will also eliminate the issues Bitcoin are dealing with currently on ledger size bringing data mining of the network to a halt, permanently. OTP would also eliminate the threat quantum computing imposes on current algorithm-based security models. Another method of this OTP model would be to perform the transactions over a web socket, which drops the IP communication from level 6 to level 4. The benefit of this is that the transaction can still communicate over an encrypted channel such as SSL or VPN, but it won't be as easy to “sniff” the data packet over the wire, or intercept the data traffic due to the fact that the communications are running on layer 4 of the Internet Protocol stack instead of layer 6 (your web browser and most other Internet enabled apps run on IPv6). In addition, it will allow for the client and server applications to conduct the transaction in a single send-receive request over the network once the web socket channel is established. This OTP design will further enhance the security model and improve overall user experience.

Another consideration of this OTP design is that the PKI complexities of talking to third party Certificate Authorities over the network to confirm identity unnecessarily has been removed. Therefore, more enhanced network architectures can be considered to expedite transactions. Consider a decentralized ledger where all the random data is broadcast to, and OTP encryption occurs in real-time. Then, consider having several cloud-based servers running web socket proxies to that decentralized ledger. If the network is designed in such a way that the web socket proxy servers are spread out over the global Internet, then digital wallet applications and any other applications that want to use this OTP mechanism can interact through a local server that has a dedicated communication channel to the repository performing all the real-time encryption and storage of records to a ledger. This network architecture will dramatically scale to meet the demands of a global payment, record and document storage facility with virtually zero network latency.

One other important matter to consider for this encryption service is that once a data packet/document/etc. is transmitted to the service, the data is encrypted and then stored, at a minimum the encryption key, and/or possibly the encrypted packet/document/etc. itself may need to be transmitted back to the user that initiated the transaction. The key and/or the encrypted data can be transmitted back to the user in the same secure data channel that they initiated the transaction from (possibly SSL, TLS, SSL over a web socket, VPN, etc.) either together or in separate transactions. Another mechanism to perform this action would be to have the encrypted packet or the key transmitted back in the same transaction via the same protocol, and then have the other piece of information being the key or the data transmitted back over another transaction or alternate communications channel. For instance, the encrypted packet can be sent back on the same transaction and the key can then be transmitted back through text messaging or email. Either response from the server to gain access to the encrypted data or the encryption key could simply be a secure link to retrieve the data as a separate transaction. Any combination of using multiple communications transactions and mediums could be used to transmit the resultant information from the service, whether it be the encrypted data, the encryption key, or information provided to retrieve either piece of information in the future. This service should also provide a secure mechanism that allows encrypted data and/or an associated encryption key to be securely submitted for decryption of the information. Once the decrypted information is produced, it can then be used by another secure service or returned to the user in a manner described in this disclosure.

One overall business/technology model for the cryptocurrency, financial, or other document management or recordkeeping system could be that the system first takes identifying information from a new user to confirm the new user's identity. This process is referred to by the banking industry as Know Your Customer/Anti Money Laundering (KYC/AML for short) and is part of regulatory requirements to ensure the user is legal and/or their funds are legal as well. Once validated, the system doesn't permanently record any specifics regarding the individual other than the confirmation of the background check and the person's basic identity for records. As an alternative privacy safeguard, the person's identifying information could be stored offline like in a safe or bank deposit box as a paper, digital or other type of storage/recording medium. The important aspect of this is that the identity of the user in the system can now become just a digital unique identifier that is only associated by the offline record. This would eliminate the threat of any hack or breach of the system to result in divulging any confidential personal information during the system's operation.

Once a deposit is issued to the system, the record of that deposit can be stored in a ledger that uses any encryption scheme including the One-Time Pad implementation described above and in the previously filed and related patents referenced herein. In doing so, the decryption key or key segments will need to be distributed in a manner consistent with the mechanisms described herein as well as in the referenced previous patent filings. That decryption key or key segments may or may not be transmitted digitally by a messaging system in one or multiple transactions to one or more locations over one or more digital transport means. The key or key segments may or may not be delivered on a physical storage device that is sent to the user of the system via some form of transport (UPS, Fedex, DHL, hand delivery, etc.). If on a physical storage device, it could be in the form of a credit/debit card, or secure device such as a USB stick or CD/DVD disk. The physical record of the key could also be printed medium such as paper so that it can be scanned by the user once it arrives and used digitally in the future. The packet or packed segments needed for identification and location of the record on the ledger, as well as the decryption key data could be any arrangement that contains the OTP decryption key, the timestamp start and finish, and the unique identifier of the user, and can be distributed to the user in any of the mechanisms mentioned for transport in any order, inclusive or exclusive.

For potential OTP ledger designs for a financial implementation, OTP-based ledgers could have two primary designs. The first is a ledger that only keeps account balance records and never records the transactions themselves. The second is one that keeps both account balance records as well as transaction records for historical context. There could be the notion of one or two record structures in the ledger for the second type of implementation. If two record types are used, one could be for user accounts, and the other could be for transaction recording. The account record could contain the unique id for the user, the timestamp the account was written to the ledger for sequencing/lookup, and the account balance itself. The transaction record could contain the unique id for the sender and/or the receiver, the timestamp the account was written to the ledger for sequencing/lookup, and the transaction record itself. These data elements could be combined in any potential permutation/order/format to achieve the desired results.

This system may operate so that no transaction history other that the minimal amount of data required to note the transaction itself is recorded, and thus no metadata history of the account activity is recorded by default during normal operation. If the ledger does record metadata and other transaction history, it could do so in a manner that can't verify both parties of a transaction historically. In other words, metadata associated with the daily financial activity and overall individual account history may only be maintained for accounting purposes required by regulators only and not for retrieving individual user activity at some point in the future. If a court subpoena or government warrant/order is issued at some point during the individual's activity with the bank, then the mechanism should allow for any future activity by said individual mentioned in the subpoena or government warrant/order to be tracked in full detail from the point in time that the subpoena or government warrant/order is provided to the system, and only performed until the investigation is concluded or law enforcement decides they no longer need access to a user's individual financial activity. This scheme will allow for individuals to participate in full privacy within the system free from the worries of hacking and other criminal activities to defraud them unless and until some “probable cause” is brought against the individual in a court system that has legal authority and requires such tracking of activity in the future. This mechanism will allow for full anonymity by the user of the system during daily operation after the user attains the bank account legally, until such an incident happens otherwise that requires their account to be monitored pursuant to a court subpoena or government warrant/order.

Future deposits into such a system from users that have already gone through the initial KYC/AML regulatory requirements will more than likely have to conform to some level of KYC/AML policy requirements by regulatory agencies during processing of the new deposit. However, such transactions should conform to the same security measures described for new users and shouldn't result in any additional information being tracked other than the amount of the deposit and the account it went into under normal operations. Such a system should perform the minimal amount of compliance to stay within regulatory guidelines and thus maintain a process that is fully legal by regulatory requirements based on the jurisdiction of the system and/or the user of the system.

This mechanism could be implemented as a separate historical transaction tracking ledger once the subpoena or warrant/order is issued, or it could be bundled in as a separate encryption scheme within the initial ledger. If the latter, there could be a default per transaction that doesn't record the previous owner of currency, and once subpoena or order is issued, that information could be recorded by default. The former seems to be more controllable and logical, but more centralized in nature. The latter seems to be the best potential for a fully decentralized mechanism to track transaction history once an account is deemed owned by a compromised entity.

The Trusted Execution Environment (TEE) architecture/protocol is based on session-keys for security as it is currently defined. OTP could be used to increase security in such transaction models to further protect the user of the system.

One possible system design could be to use OTP in conjunction with TEE for securing communications with a ledger between one or more parties. An application running on a computing device could be used to make a payment with the OTP service described previously. The application creates an encrypted connection (VPN, SSL, SSH, etc.) with a server environment that implements an OTP service along with a random number stream described above which is needed for OTP encryption/decryption. The application sends information over the secure connection that may include the length of the payment packet that needs to be encrypted along with potentially identifiable information such as the hardware encryption key generated by the TEE implementation on the device. The server environment then creates a packet of data that contains the starting timestamp of when the data from the random data stream is being captured along with a segment of random data from that point in the random data stream forward in order that is the size of the packet that needs to be encrypted on the device. The server then sends the data packet containing the start timestamp and the encryption key back to the device. Once the device receives the packet, it writes the timestamp in memory and uses the TEE hardware encryption key to asymmetrically or symmetrically encrypt against the OTP encryption key generated by the server, and the output is then XORed with the payment packet to complete the encryption of the payment data packet.

The TEE hardware encryption key could also be used to asymmetrically or symmetrically encrypt the payment packet first, and the output is then XORed with the OTP encryption key provided by the server. Any additional encryption combination using one or both keys in any encryption sequence could be applied to the payment packet on the device to secure the payment data. Once the payment data is encrypted, the application can then send the data to all servers in the system for storage on the ledger. This could occur by the device application sending the encrypted packet over an encrypted connection to each server in the system individually, or as a broadcast, or by sending to a server-side service that will then forward the encrypted packet to every server in the ledger system. Once the payment data is recorded across all ledgers, a verification system running on the server side could be sent a request with the start timestamp and the length of the payment data record. The verification service could then lookup the newly recorded data on each individual copy of the ledger in the server environment by seeking to the timestamp in each copy of the ledger and comparing the data that follows based on the payment data packet length. If the data across all ledgers is identical, then the transaction was successful and the server can notify the application on the device that the data was stored on the ledger correctly.

The underlying data packet structure could take several forms including one that references data before the record being written to the ledger, or references the previous transaction by that particular device on the ledger. The application on the device may or may not write any part of all of the encrypted payment packet and/or encryption keys, timestamp, or packet size to protected memory in the TEE or encrypted data storage somewhere else on the device or a peripheral of the device like a USB memory stick, etc. After completion of the transaction to OTP encrypt the payment and store it on a distributed ledger, the application can then contact the recipient of the payment via an application on the recipient's device to relay information regarding how to redeem the payment. This can be done through a direct or peer-to-peer encrypted connection, or through an encrypted messaging service such as encrypted SMS, encrypted email, or other encrypted proprietary messaging protocol. Information sent to the recipient could be sent over multiple messages over one or more of the messaging methods mentioned above, and could include the timestamp the encryption started to lookup the payment record on the ledger as well as the length of the payment record, as well as the OTP encryption key and/or the encrypted data. When the device application of the recipient requests to redeem the payment from the ledger, then the recipient application sends a request to the server that contains the timestamp of the payment record and the size of the record. The server then seeks to the timestamp location on the ledger and reads the data based on the size provided in the request. The server then sends the data to the recipient application over an encrypted connection or messaging service, and the recipient application can then decrypt the payment record in the TEE so that the data is fully secured during decryption. The record can then be stored in encrypted and/or cleartext in TEE memory or in a secure data store on the recipient device or peripheral. This could all happen as one or many transactions across the ledger system.

The main design element here is that the applications performing the payments never have to expose any encryption and/or decryption information, including lookup information for the data on the ledger, to any unsecured area of the client device because all the encryption and decryption on both the devices involved in the payment transaction occurred in TEE and communicated with the server environment managing the distributed ledger over encrypted connections, so the entire transaction sequence across both devices is fully encrypted. Another primary design element is the server environment could destroy the OTP key once the transaction is completed and verified as stored on the ledger successfully and accurately across all ledger copies, or never write the OTP key to memory after being provided to the application initiating the transaction. This could ensure that even the server environment cannot retrieve individual records from the ledger, protecting the data permanently for both participants in the payment transaction. Any modification/inclusion/exclusion of storage and key management steps described in this mechanism can be considered. In addition, this combination of OTP and/or TEE and/or encrypted peer-to-peer transaction processing and ledger use over encrypted connections such as VPN can be performed in any order to achieve the desired result of secure payment processing. This mechanism may or may not require sending the TEE encryption key for any device to the server for future identification and encryption processing. If the TEE encryption key is sent to the server for storage and any time during use, it can be used to encrypt and/or decrypt data packets as needed during operation for accessing data or managing records and accounts. The recipient could potentially request the hardware key of the payment sender from the server as well and receive the OTP key from the payment initiating device application directly so to further complicate the key management and thus make it harder to break into the security implementation. This mechanism can also be used to store any other form of data on a decentralized ledger in a secure manner involving one or more devices communicating with one or more servers managing one or more copies of a decentralized ledger. The device application could be accessed by a user provided password, or by any combination of biometric access mechanisms built into the device or programmed into the application. This includes all the password mechanisms mentioned in previous patent filings referenced herein.

The OTP-based distributed ledger described above and in previous patent filings mentioned herein could be supplied alongside a symmetric or asymmetric encryption-based ledger as a permanent immutable backup that can't be hacked. This OTP backup could be used as a sidechain or blockchain running in parallel of the primary symmetric or asymmetric encryption system.

Another mechanism that can be used by this blockchain/cryptocurrency system is to use some of the tokens/cryptocurrency created by or transferred into the blockchain to collateralize a financial arrangement such as a bank loan. The mechanism could set aside one or more cryptocurrency tokens/coins and enter into a financial contract with a bank, financial institution, or other financial services company or agency whereby the cryptocurrency or other token is used as collateral for some Fiat-based financial arrangement. This in effect could create the basis for an entirely new set of financial instruments based on blockchain technology.

The blockchain systems described in this and other patent disclosures referenced herein could use the OTP and/or TEE implementations described herein to secure any social media sites such as Facebook, SnapChat, Instagram, LinkedIn etc. or any new social media site that needs user security on a blockchain.

This system could use the carbon credit validation report generated in accordance with ISO-14064 standards and described in previous patent filings referenced herein to create new cryptocurrency units/coins/tokens/etc. for a particular entity so that the cryptocurrency creation is considered a primary market activity. This of course would make any cryptocurrency created in this manner not under the oversight of any regulatory body including the US Securities and Exchange commission since they only have legal right to regulate secondary market activities.

An alternative mining mechanism could be Proof of Elapsed Time in Concert (PoETiC). What if the initiator of a processing transaction to earn This Cryptocurrency, or someone wanting to earn cryptocurrency without using a lot of electricity or wants to generate cryptocurrency from a computing device that has an interface but doesn't have mining characteristics such as a smart phone, tablet, or laptop, has an alternate mechanism to gather several more registered participants and spend a short amount of time face-to-face with them to earn cryptocurrency. Could be conducted in a manner that independently encourages people to spend 15 mins or more together with no processing availability from their computing devices to just “hang out”. The group could earn cryptocurrency by spending social time together, and double credits if they actually discussed things that matter to them in a socially positive manner and publish the positive interactions online. This would encourage positive social interaction potentially across social barriers over time.

As a One-Time Pad (OTP) implementation, consider the following. Implement a number of random number generation computer facilities, whether they be based on Geiger Counter measurements of release of electrons from radioactive isotopes, voltage fluctuations from solar panels, or some other scheme to create a random number sequence that is accepted by industry experts as truly “random”. These computing facilities could be located in various locations all over the planet, or in a specific single geographic location. Then have all the computing facilities broadcast their occurrence differential on a timed interval with timestamp included to the rest of the computing facilities, or alternative servers that will build the random number sequence in the network. These computing facilities, or alternative servers, could simple collect the broadcasted updates from each computer producing the random number output from Geiger Counter measurement devices or otherwise, and then record the random number or sequence of numbers associated with the update that is deemed most determinate in the timeframe it was issued. In other words, each receiving computer on the network could record the random number, or number sequence, associated with the timestamp most close to the time interval being recorded, least close, or some other deterministic approach to accepting a random number and/or sequence with a given timeslot on the random number sequence being generated. This would allow for the random number sequence, or the OTP encryption key sequence, to be recorded by one or more computers in the network without the exact random number sequence ever being exposed to any computer outside the network or available on the network but not participating in the random number sequence processing and creation itself.

An example of the above would be if one or more computing facilities had uranium saturated soil being monitored by Geiger Counters for electron release, and each would send an update to the network of receiving computers as the event occurs, along with the timestamp it occurred, then each receiving computer would then decide on which random number update to record as part of the final random number sequence. This could be accomplished by having each receiving computer record the update received based on it's timestamp relative to the overall random number sequence. In other words, if the random number sequence needs a new entry every microsecond, then each computer on the network needs to receive one and/or all updates from the random number generation production facilities within microseconds as a time interval, and then needs to accept one of the updates for that timeslot based on a predetermined characteristic. This predetermined characteristic could be based on the timestamp that is closest to the time interval the random number sequence is generated on. In other words, many facilities could stream out an update within every microsecond, and then every receiving computer constructing the random number sequence could collect all updates and choose the closest to the determinate chosen, which more than likely will be the closest update in time to the timestamp interval chosen. If all packets of data are transmitted correctly, the random number sequence can be generated in a manner that is one-way in data sent and doesn't need final confirmation between receiving computers creating the random number sequence to produce identical results. There could be a two step or four phase transaction tier implemented to ensure that the random number sequences between all computers on the network are kept in sync without response verification of the random number sequence itself. In other words, if the initial broadcast can't guarantee a specific and unique random number per time interval required by the DLT, then the DLT mechanism should have some backup for broadcasting out the random number per time interval required for the OTP scheme described herein to ensure that all copies of the random number sequence as well as the encrypted ledger are in sync.

Once the random number sequences are built on all receiving computers, these computers can send the random number sequence to other computers for encrypting data via One Time Pad techniques, or they can perform the encryption themselves. One way to perform this would be to have external computers accept data from a user of the network and transmit the data via secure communications (VPN, SSL, SSH, HTTPS, etc.) to the computer that will perform the encryption/decryption of the data. These secure communications mechanisms can be used in any aspect of this OTP ledger implementation.

An extended method for encrypting/decrypting the data would be for the user to specify the start and/or end date of when the packet was encrypted, along with their private encryption key, which could have been used along with the OTP key to further encrypt/decrypt the data referenced. Once the data is encrypted, the encrypted portion can then be broadcast along with the start or end timestamp or other identifying information to all the other computers in the network for recording on their own encrypted ledger copy. One such mechanism for broadcasting encrypted data for ledger entry by other computers on the network would be to run a one-way hash algorithm over the initial data using algorithms such as MD4, MD5, SHA, SHA-256, or some other one-way hash algorithm, and then sending the hash of the original message along with the encrypted data for storage on another ledger copy on another computer. Then the encrypted data can be decrypted by the receiving computer and run through the same hash algorithm to see if the data packet is valid and complete after reception. Any other encryption/decryption schemes such as using symmetric encryption algorithm may also be used.

One such mechanism would be to encrypt the data, secure hash the data itself with the user's private key and build a data packet comprised of the timestamp of when it was created, the encrypted data, a secure hash of the original data, and potentially the user's private key. This data packet can then be broadcast out to all computers managing the decentralized ledger. Once this data packet arrives at all other computers managing their own copies of the ledger, they can then decrypt the data portion of the packet and generate a hash or other representing encryption key or data packet. The hash can then be compared with the original hash in the broadcasted packet to confirm authenticity of the payload data in the packet and/or confirmation of proper storage of said data to the ledger. Once confirmed, the encrypted data can be written into the local copy of the ledger based on timestamp or some other sequence.

OTP generally requires that some of the encryption keys and all data packets encrypted are of the same length. Therefore, they can both be referenced on a timestamp-based random number sequence and/or decentralized ledger by the same timestamp. What is meant by a timestamp-based ledger is a ledger that records data on a specific time interval. In other words, if a ledger is based on microsecond-based time intervals, then a new digital value will be recorded every microsecond on the ledger such that each data point can be retrieved by an interval of time if needed as that is how the data is being recorded. Such a network would allow users to send data to any one of the computers that has access to the random number sequence and that computer can then encrypt it for storage on the network. The computer can then record the encrypted data in its' own OTP-based ledger as well as broadcast out the encrypted data to the rest of the network so it can be recorded on every other OTP-based ledger copy. This will keep all OTP ledger copies in the network in sync without ever exposing the decryption key to any outside parties. When a user needs to decrypt data from the OTP-based decentralized ledger, they can login to any single computer on the OTP ledger network and have it decrypt and send any information the user has credentials to access. This OTP encryption/decryption mechanism could be implemented on an Internet-enabled or offline network, or a hybrid of the two in any derived format. It could also include any trusted execution environment for recording and retrieving any of the OTP encryption/decryption keys, information related to private encryption keys, as well as any other information needed to secure and/or access date secured by this encryption/storage/decryption mechanism.

It requires a set of computing stations that will generate random sequences on their own. Then each station will broadcast a packet of data containing the last random number or a sequence of random numbers generated, and a timestamp on a timed interval (probably microsecond) out to a global network of receiving computers that will build the random number ledger independently of each other. All the servers will be blind to each other as well as the computing stations creating the random data but will all come to the same conclusion on which random numbers to use in sequence based on the broadcasted packets from the initial computing stations. The determinant may simply be the packet that falls closest to the microsecond it was generated after, or the scheme may impose some algorithm that chooses the packet to use for each time segment (within each microsecond) across all receiving computers. This will work in a networked environment as the OTP Ledger encryption sequence can be generated in advance if desired, and therefore message buffering can be used to satisfy network latency that may interrupt packet delivery at that frequency and still render the desired results.

Each receiving computer will remotely normalize on a single random number packet per timestamp segment, potentially to the microsecond, and drop all other packets within that timestamp, or append the entire random data packet to the ledger, so that remote servers will construct the OTP encryption key sequence without anyone being able to intercept the sequence en route over a single communications channel, or by compromising a single generation station. This will occur due to the fact that the random number ledger used for the OTP encryption/decryption implementation will be created from a collective broadcast of all computing stations and will be assembled in real-time on each receiving computer managing a local copy of the OTP ledger. Of course, all communication between the computing stations generating the random numbers and the receiving computers that build the random number sequence for the OTP implementation should be required to run behind enterprise firewalls over VPN at all times to ensure integrity.

Once the encryption sequence is built on each receiving computer in the network, data packets can then be assembled and submitted to the OTP network for encryption, validation, and storage in a fully redundant environment.

Another aspect of this mechanism could be to have a centralized/singleton mechanism that can manage reserving a segment of the random number sequence for encryption. This mechanism should reserve a section of the random number sequence for use by a specific transaction by having the individual computer processing the transaction submit it's start time and packet length to the centralized/singleton mechanism. Therefore, subsequent transactions reporting to the centralized/singleton computing environment can be coordinated to not overlap each other on the OTP based blockchain/ledger/storage facility.

1. A computer-implemented method of communication between a network-connected device and a remote server via a network, wherein the connected device comprises a sensor, the method comprising:
at the network-connected device, creating a true random sequence using a source of random data;
at the network-connected device, registering onto a blockchain ledger;
at the network-connected device, writing the random sequence to the blockchain ledger;
at the remote server, receiving the blockchain ledger;
at the remote server, extracting the random sequence from the blockchain ledger;
at the remote server, creating a one-time pad key using the true random sequence;
at the remote server, sending the one-time pad key to the network-connected device in a secure manner.

2. The method of claim 1, further comprising:
at the network-connected device, receiving the one-time pad key;
at the network-connected device, encrypting a data message using the one-time pad key;
at the network-connected device, writing the encrypted message to the blockchain ledger;
at the remote server, receiving the blockchain ledger;
at the remote server, extracting the encrypted message from the blockchain ledger;
at the remote server, decrypting the encrypted message using the one-time pad key.

3. The method of claim 1, further comprising:
at the remote server, encrypting a data message using the one-time pad key;
at the remote server, writing the encrypted message to the blockchain ledger;
at the network-connected device, receiving the blockchain ledger;
at the network-connected device, extracting the encrypted message from the blockchain ledger;
at the network-connected device, decrypting the encrypted message using the one-time pad key.

4. The method of claim 1, wherein the source of random data is measurement data from the sensor on the connected device.

5. The method of claim 4, wherein the sensor is a Geiger counter and the measurement data is the amount of radioactive decay from a radioactive isotope that is being measured.

6. The method of claim 4, wherein the sensor is an electrical sensor and the measurement data is the amount of electrical power, electrical energy, voltage, current (amperes), or power factor.

7. The method of claim 4, wherein the sensor is a sunlight sensor and the measurement data is the amount of sunlight being detected.

8. The method of claim 1, wherein the network-connected device is a personal computing device, and the sensor measures barometric pressure, magnetic field, or inclination.

9. The method of claim 1, wherein the sensor is a thermal sensor.

10. The method of claim 9, wherein the thermal sensor measures temperature from geologic activity.

11. The method of claim 2, wherein the length of the one-time pad key is at least the length of the encrypted message.

12. The method of claim 3, wherein the length of the one-time pad key is at least the length of the encrypted message.

13. An Internet-of-Things system, comprising:
(a) an Internet-connected device comprising:
a sensor that generates a stream measurement data;
a computing processor;
(b) a remote server in communication with the Internet-connected device via the Internet;
(c) wherein the processor in the connected device is programmed to perform operations comprising:
receive the stream of measurement data from the sensor;
create a random sequence using the stream of measurement data;
register onto a blockchain ledger;
write the random sequence to the blockchain ledger;
(d) wherein the remote server is programmed to perform operations comprising:
receive the blockchain ledger;
extract the random sequence from the blockchain ledger;
create a one-time pad key using the random sequence;
send the one-time pad key to the Internet-connected device in a secure manner.

14. The system of claim 13, further comprising:
(e) wherein the computing processor in the Internet-connected device is further programmed to:
receive the one-time pad key;
encrypt a data message using the one-time pad key;
write the encrypted message to the blockchain ledger;
(f) wherein the remote server is further programmed to:
receive the blockchain ledger;
extract the encrypted message from the blockchain ledger;
decrypt the encrypted message using the one-time pad key.

15. The method of claim 13, further comprising:
(e) wherein the remote server is further programmed to:
encrypt a data message using the one-time pad key;
write the encrypted message to the blockchain ledger;
(f) wherein the computing processer in the Internet-connected device is further programed to:
receive the blockchain ledger;
extract the encrypted message from the blockchain ledger;
decrypt the encrypted message using the one-time pad key.

16. The system of claim 13, wherein the sensor is a Geiger counter and the measurement data is the amount of radioactive decay from a radioactive isotope that is being measured.

17. The system of claim 13, wherein the sensor is an electrical sensor and the measurement data is the amount of electrical power, electrical energy, voltage, current (amperes), or power factor.

18. The system of claim 13, wherein the Internet-connected device is a personal computing device, and the sensor measures barometric pressure, magnetic field, or inclination.

19. The system of claim 14, wherein the length of the one-time pad key is at least the length of the encrypted message.

20. The method of claim 15, wherein the length of the one-time pad key is at least the length of the encrypted message.

21. A computer-implemented method of forming encrypted data for a plurality of user data, comprising:
receiving plurality data from a physical data sensor;
encrypting the plurality of user data via the plurality of received sensor data;
forwarding an encryption key and encrypted data identifier to a user electronically; and
storing the encrypted data and its identifier.

22. The method of claim 21, wherein the sensor data is electrical energy measurement data.

23. The method of claim 21, wherein the sensor data is radiation measurement data.

24. The method of claim 21, wherein the sensor data is solar energy measurement data.

25. The method of claim 21, wherein the sensor data is collected from an Internet of Things device incorporating a sensor to measure and collect the sensor data.

26. The method of claim 21, wherein forming a one-time pad (OTP) with via the plurality of received sensor data and encrypting the plurality of user data via the OTP.

27. The method of claim 21, further comprising storing the encrypted data and its identifier in an offline server.

28. The method of claim 21, further comprising storing the encrypted data and its identifier in a cloud server.

29. The method of claim 21, further comprising storing the encrypted data and its identifier in a block chain server.

30. The method of claim 25, wherein forming a one-time pad (OTP) with via the plurality of received sensor data and encrypting the plurality of user data via the OTP.

31. The method of claim 25, further comprising storing the encrypted data and its identifier in a cloud server.

32. The method of claim 25, further comprising storing the encrypted data and its identifier in a block chain server.

33. The method of claim 25, wherein the sensor data is electrical energy measurement data.

34. The method of claim 25, wherein the sensor data is radiation measurement data.

35. The method of claim 25, wherein the sensor data is solar energy measurement data.

36. The method of claim 26, wherein the sensor data is electrical energy measurement data.

37. The method of claim 26, wherein the sensor data is radiation measurement data.

38. The method of claim 26, wherein the sensor data is solar energy measurement data.

39. The method of claim 26, further comprising storing the encrypted data and its identifier in an offline server.

40. A computer-implemented method of trading carbon credits using a cryptocurrency market platform:
at a first site, obtaining carbon credits;
at the first site, submitting the carbon credits to a cryptocurrency market platform;
on the cryptocurrency market platform, issuing cryptocurrency to the first site and to an account for renewable energy;
at a second site, mining cryptocurrency for the cryptocurrency market platform;
on the cryptocurrency market platform, issuing cryptocurrency to the second site and to the account for renewable energy;
converting the cryptocurrency in the account for renewable energy into fiat currency;
using the fiat currency to build renewable energy production facilities.

41. The method of claim 40, wherein the first site is an energy utility.

42. The method of claim 40, wherein the cryptocurrency market platform is implemented using proof-of-elapsed time (PoET)

43. The method of claim 40, further comprising, at a third site, buying cryptocurrency on the cryptocurrency market platform.

44. A system for trading carbon credits, comprising:
(a) a first server to serve as a cryptocurrency market platform;
(b) a second server for collecting cryptocurrency designated for renewable energy;
(c) a third server for storing carbon credits;
(d) a fourth server for mining cryptocurrency for the cryptocurrency market platform;
wherein the third server submits carbon credits to the first server for the cryptocurrency market platform;
wherein the first server for the cryptocurrency market platform issues cryptocurrency to the second server and the third server;
wherein the second server converts the cryptocurrency into fiat currency for building of renewable energy facilities;
wherein the fourth server mines cryptocurrency for the cryptocurrency market platform;
wherein the first server cryptocurrency to the second server and the third server.

41. The method of claim 40, wherein the first site is an energy utility.

42. The method of claim 40, wherein the cryptocurrency market platform is implemented using proof-of-elapsed time (PoET)

43. The method of claim 40, further comprising, at a third site, buying cryptocurrency on the cryptocurrency market platform.

44. A system for trading carbon credits, comprising:
(a) a first server that operates a cryptocurrency market platform;
(b) a second server for collecting cryptocurrency designated for renewable energy;
(c) a third server for storing carbon credits;
(d) a fourth server for mining cryptocurrency for the cryptocurrency market platform;
wherein the third server submits carbon credits to the first server for the cryptocurrency market platform;
wherein the first server for the cryptocurrency market platform issues cryptocurrency to the second server and the third server;
wherein the second server converts the cryptocurrency into fiat currency for building of renewable energy facilities;
wherein the fourth server mines cryptocurrency for the cryptocurrency market platform;
wherein the first server issues cryptocurrency to the second server and the fourth server.

45. The system of claim 44, wherein the third server is operated by an energy utility.

46. The system of claim 44, wherein the cryptocurrency market platform is implemented using proof-of-elapsed time (PoET)

47. The system of claim 40, further a fifth server that buys cryptocurrency on the cryptocurrency market platform.

48. The system of claim 44, wherein blockchain distributed ledger technology is installed on the first server.

49. The system of claim 48, wherein a Trusted Execution Environment (TEE) is installed on the fourth server.

50. The system of claim 44, further comprising a renewable energy facility that is built from the fiat currency collected and converted by the second server.
